(19) United States
(12) Patent Application Publication
(10) Pub. No.: US 2009/0265105 A1
(43) Pub. Date: Oct. 22, 2009

(54) REAL-TIME NAVIGATION DEVICES, SYSTEMS AND METHODS

(75) Inventors: Dwayne A. Davis, Reno, NV (US); Michael M. Oberberger, Reno, NV (US); Christiaan R. Champagne, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT

(21) Appl. No.: 12/106,771

(22) Filed: Apr. 21, 2008

(51) Int. Cl. G01C 21/00; G06Q 30/00; H04N 7/00

(52) U.S. Cl. 701/300; 705/10; 348/113; 348/E05.024

(57) ABSTRACT

Some implementations of the invention provide real-time navigation data via a mobile device. Some embodiments of the invention provide portable devices that can indicate both relatively “static” information, such as map data, architectural features, casino layout information, etc., which may be updated from time to time. Accordingly, the term “static” as used herein does not necessarily mean unchanging or unchangeable. Some such embodiments provide portable devices that can simultaneously display static information and real-time video data. The video data may be provided by one or more cameras in a camera network. Information, such as offers, advertisements, etc., may be provided to a user according to the user's location.

### FIELD OF THE INVENTION

The present invention relates generally to navigation devices and systems.

### BACKGROUND OF THE INVENTION

As time goes by, new casinos are being built on a larger and larger scale. (Although there are many types of gaming establishments, including casinos, cruise ships, riverboats, etc., all types of gaming establishments may sometimes be referred to herein as “casinos.”) There are many perceived advantages to large-scale casinos. Many large-scale casinos have proven to be very popular and very profitable.

However, casinos have become so large as to be difficult to navigate. Some are so large that it may be difficult for patrons to locate desired types of wagering games, desired restaurants, coffee shops, retail shops, etc. Signage in a casino may not provide enough guidance. Some patrons are not proficient at reading the printed casino maps that are currently provided. It would be desirable to provide more versatile navigation methods and devices, particularly for use in casinos.

### SUMMARY OF THE INVENTION

Some implementations of the invention provide improved navigation methods, devices and systems. Many such implementations involve providing real-time navigation data via a mobile device. Although many such devices, etc., are described herein in the context of casinos, the invention is not so limited.

Some embodiments of the invention provide portable devices that can indicate both relatively “static” information, as well as information that is more frequently updated. Such “static” information may include navigation information, such as map data, architectural features, casino layout information, etc., that may be updated from time to time. Accordingly, the term “static” as used herein does not necessarily mean unchanging or unchangeable. Moreover, the term “static” does not necessarily mean “motionless” or the like. For example, displayed “static” images may appear to change orientation, shape, etc., as a viewer's perspective changes, e.g., as a device proceeds through an actual or virtual space.

Some such embodiments provide portable devices that can simultaneously display static images and other image data e.g., real-time video data provided by one or more cameras in a camera network. In some implementations, at least some cameras of an existing camera network, such as a security camera network, may be used to provide images. In some such implementations, the selecting step comprises selecting at least one security camera deployed in a gaming establishment.

However, some implementations involve selecting cameras from a camera network that is established for the primary purpose of providing navigation images according to the present invention. Although such a camera network may sometimes be referenced herein as a “dedicated” camera network or the like, cameras in such a network may nonetheless be used for other purposes, e.g., as a supplement to an existing network of security cameras.

Some implementations of the invention provide a method of providing real-time navigation data that includes the following steps: determining a location of a device; selecting at least one camera having a viewpoint that corresponds with the device location; obtaining video data from at least one selected camera; aligning the video data with static images of objects near the device location; and displaying the static images and the video data on the device, according to the device location.

The determining step may involve determining an actual device location. For example, the determining step may involve determining the actual device location by reading a radio frequency identification tag associated with the device, via a triangulation technique via the Global Positioning System, etc.

However, the determining step may involve determining a virtual device location. In some such implementations, the static images and the video data correspond with the virtual location. A virtual tour of an area may be provided, e.g., by displaying static images and presenting video data corresponding to a sequence of virtual device locations. Providing a virtual tour may involve displaying static images and/or presenting video data corresponding to a sequence of virtual device orientations.

The method may also involve ascertaining a device orientation. The displaying step may comprise displaying the static images and the video data on the device according to the device orientation. The static images and/or the video data may correspond with a virtual orientation or an actual device orientation. The ascertaining step may involve ascertaining a change in orientation of at least one gyroscope and/or ascertaining a change in device orientation via a directional receiver.

The displaying step may involve displaying static images of a gaming establishment. The selecting step may involve selecting at least one camera of a network of cameras, e.g., in a gaming establishment. For example, the selecting step may comprise selecting at least one security camera deployed in a gaming establishment. The selecting step may comprise selecting more than one camera of a network of cameras. If so, the obtaining step may involve obtaining video data from each selected camera. In some such implementations, the method may further comprise forming a composite image from the video data from each selected camera.

The aligning step may involve matching at least a first portion of a first polygon in a static image with a second portion of a second polygon in an image of the video data. The aligning step may involve aligning a first point in a static image with a second point in an image of the video data. The aligning step may comprise applying a mathematical transformation of video data taken from a camera viewpoint to produce video data from a device viewpoint.

The method may involve providing wagering games via the device. The method may comprise offering a benefit corresponding with a device location. The benefit may involve a wager gaming opportunity, goods and/or services. The benefit may correspond to preference data for a user of the device. The method may involve obtaining the preference data from a player loyalty database.

These and other methods of the invention may be implemented by various types of hardware, software, firmware, etc. For example, some features of the invention may be implemented, at least in part, by a personal digital assistant, by a portable gaming device and/or other type of mobile device, by one or more host devices, servers, cameras, etc. Some embodiments of the invention are provided as computer programs embodied in machine-readable media. The computer programs may include instructions for controlling one or more devices to perform the methods described herein.

Alternative embodiments of the invention may comprise an apparatus for providing real-time navigation data. The apparatus may include a network interface system comprising at least one network interface and a logic system comprising at least one logic device. The logic system may be configured to do the following: receive data via the interface system regarding a device location; select at least one camera having a viewpoint that corresponds with the device location; obtain video data from at least one selected camera; and transmit the video data to the device via the interface system.

The received data may comprise data regarding an actual device location. The logic system may be further configured to determine the actual device location according to an indication received via the interface system that a radio frequency identification (“RFID”) reader has read an RFID tag associated with the device. The logic system may be further configured to determine the actual device location according to a triangulation technique, based on a plurality of signals received via the interface system.

The logic system may be configured to offer a benefit according to the device location. The benefit may comprise a wager gaming opportunity, goods and/or services. The benefit may correspond to preference data for a user of the device. The logic system may be further configured to obtain, via the interface system, the preference data from a player loyalty database.

The apparatus may receive data regarding a virtual device location. Video data may be provided that correspond with the virtual location. The logic system may be further configured to prepare and transmit video data corresponding to a sequence of virtual device locations.

The apparatus may be further configured to receive data via the interface system regarding a device orientation and to orient the video data according to the device orientation. The orienting may involve matching at least a first portion of a first polygon in a static image with a second portion of a second polygon in an image of the video data. The orienting may involve aligning a first point in a static image with a second point in an image of the video data. The orienting may involve applying a mathematical transformation of video data taken from a camera viewpoint to produce video data from a device viewpoint. The device orientation may comprise an actual device orientation or a virtual device orientation. The video data may correspond with the actual device orientation or the virtual device orientation. For example, the logic system may be further configured to prepare and transmit video data corresponding to a sequence of virtual device orientations.

The selecting step may involve selecting at least one camera of a network of cameras. The selecting step may involve selecting more than one camera of a network of cameras and the obtaining step may involve obtaining video data from each selected camera. The logic system may be further configured to form a composite image from the video data from each selected camera. The selecting step may comprise selecting at least one camera deployed in a gaming establishment.

Alternative embodiments may comprise an apparatus for providing real-time navigation data. The apparatus may include the following elements: an interface system comprising at least one wireless interface; a display system comprising at least one display device; orientation means for determining an orientation of the apparatus; a memory system comprising at least one type of memory device; and a logic system comprising at least one logic device.

The logic system may be configured to do the following: determine a location of the apparatus; ascertain an orientation of the apparatus; receive video data, via the interface system, from at least one selected camera having a viewpoint that corresponds with the device location and orientation; and control the display system to display simultaneously the video data and static images of objects near the apparatus location, according to the apparatus location and orientation.

The determining step may comprise determining an actual apparatus location. For example, the apparatus may further comprise a radio frequency identification (“RFID”) tag and the determining step may comprise receiving, via the network interface, a location of an RFID reader that has read the RFID tag. Alternatively, , the apparatus may further comprise a radio frequency identification (“RFID”) reader, wherein the determining step comprises determining a location of an RFID tag read by the RFID reader. The apparatus may further comprise a Global Positioning System (“GPS”) unit and the determining step may comprise receiving location data from the GPS unit. The ascertaining step may comprise determining an actual apparatus orientation, according to orientation data from the orientation means.

However, the determining step may comprise determining a virtual apparatus location. The ascertaining step may comprise determining a virtual apparatus orientation. The static images and/or the video data may correspond with the virtual location and/or the virtual orientation. The logic system may be further configured to control the display system to provide a virtual tour of an area, e.g., by displaying static images corresponding to a sequence of virtual device locations and virtual device orientations.

The apparatus may further comprise a user interface. The determining step may comprise receiving, via the network interface, at least one of a virtual device location or a virtual device orientation. The logic system may be further configured to control the display system to display video data corresponding to the sequence of virtual device locations and virtual device orientations. The apparatus may further include an audio system comprising at least one sound-producing device. The logic system may be further configured to control the audio system to provide information corresponding to a sequence of virtual device locations and/or virtual device orientations.

The orientation means may comprise a gyroscope system that includes at least one gyroscope. The orientation means may comprise an antenna.

The controlling step may involve controlling the display system to display static images of a gaming establishment. The logic system may be further configured to obtain static image data from the memory system. The logic system may be further configured to match at least a first portion of a first polygon in a static image with a second portion of a second polygon in an image of the video data. The logic system may be further configured to align at least one static image reference point with at least one corresponding video data reference point. The logic system may be further configured to apply a mathematical transformation of video data taken from a camera viewpoint to produce video data from an apparatus viewpoint. The logic system may be further configured to select a portion of a field of view of received video data corresponding with a displayed field of view of static image data.

The determining step may involve receiving location data via the network interface. The logic system may be further configured to control the display device to offer a benefit corresponding with the device location. The apparatus may further comprise an audio system including at least one sound-producing device. The logic system may be further configured to control the audio system to provide information corresponding with the device location. The logic system may be further configured to control the audio device to offer a benefit corresponding with the device location. The apparatus may further comprise means for providing wagering games.

Some embodiments comprise a system for providing real-time navigation data. Such a system may include these elements: apparatus for determining a location of a device; apparatus for ascertaining an orientation of the device; apparatus for displaying static images of objects near the device location, according to the device orientation; apparatus for selecting at least one camera having a viewpoint that corresponds with the device location and orientation; apparatus for obtaining video data from at least one selected camera; apparatus for orienting the video data with the static images; and apparatus for presenting the video data on the device.

The determining apparatus may comprise apparatus for determining an actual device location. The ascertaining apparatus may comprise apparatus for determining an actual device orientation. The determining apparatus may comprise apparatus for determining the actual device location by reading a radio frequency identification tag associated with the device. The determining apparatus may comprise apparatus for determining the actual device location via a triangulation technique. The determining apparatus may comprise apparatus for determining the actual device location via a Global Positioning System.

The determining apparatus may comprise apparatus for determining a virtual device location. The ascertaining apparatus may comprise apparatus for determining a virtual device orientation. The static images and/or the video data may correspond with the virtual location and/or the virtual orientation. The system may further comprise apparatus for providing a virtual tour of an area by displaying static images and/or presenting video data corresponding to a sequence of virtual device locations and orientations.

The ascertaining apparatus may comprise a gyroscope system comprising at least one gyroscope. The ascertaining apparatus may comprise a directional receiver.

The display apparatus may comprise apparatus for displaying static images of a gaming establishment. The display apparatus may comprise a display of a mobile device.

The selecting apparatus may comprise apparatus for selecting at least one camera of a network of cameras. The selecting apparatus may comprise apparatus for selecting more than one camera of a network of cameras. The obtaining apparatus may comprise obtaining video data from each selected camera. The system may further comprise apparatus for forming a composite image from the video data from each selected camera. The selecting apparatus may comprise apparatus for selecting at least one camera deployed in a gaming establishment.

The orienting apparatus may comprise apparatus for matching at least a first portion of a first polygon in a static image with a second portion of a second polygon in an image of the video data. The orienting apparatus may comprise apparatus for aligning a first point in a static image with a second point in an image of the video data. The orienting apparatus may comprise apparatus for applying a mathematical transformation of video data taken from a camera viewpoint to produce video data from a device viewpoint.

The system may further comprise apparatus for offering a benefit corresponding with a device location. The benefit may comprise a wager gaming opportunity, goods and/or services. The benefit may correspond to preference data for a user of the device. The system may further comprise apparatus for obtaining the preference data from a player loyalty database. For example, the obtaining apparatus may comprise a player loyalty server.

The system may further comprise apparatus for providing static image data. For example, the apparatus for providing static image data may comprise a server. The apparatus for providing static image data may comprise a data structure stored in a memory of a mobile device.

### BRIEF DESCRIPTION OF THE DRAWINGS

FIG. 1A depicts an example of a gaming establishment and related devices that may be used for some implementations of the invention.

FIG. 1B depicts an example of an alternative gaming establishment and related devices that may be used for some implementations of the invention.

FIG. 1C depicts an example of a portion of a gaming establishment and related devices that may be used for alternative implementations of the invention.

FIG. 1D depicts a simplified example of a portion of a gaming establishment and related devices that may be used for other implementations of the invention.

FIG. 2 is flow chart that outlines steps of some methods of the invention.

FIGS. 3A and 3B illustrate how cameras may provide image data to mobile devices according to some implementations of the invention.

FIG. 4 is a flow chart that outlines some methods of the invention.

FIG. 5 is a block diagram of a mobile device according to some implementations of the invention.

FIG. 6 illustrates features for filter processes according to some aspects of the invention.

FIG. 7 is a flow chart that outlines some methods of the invention.

FIG. 8 is a diagram of a mobile device according to some implementations of the invention.

FIG. 9 is a diagram of a network device that may be configured according to some implementations of the invention.

### DESCRIPTION OF EXAMPLE EMBODIMENTS

In this application, numerous specific details are set forth in order to provide a thorough understanding of the present invention. However, the present invention may be practiced without some or all of these specific details. In other instances, well known process steps have not been described in detail in order to avoid obscuring the present invention. Accordingly, the methods described herein may include more (or fewer) steps than are indicated. Moreover, the steps of such methods are not necessarily performed in the order indicated.

Reference will now be made in detail to some specific examples of the invention, including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

Various techniques and mechanisms of the present invention will sometimes be described in singular form for clarity. However, it should be noted that some embodiments include multiple iterations of a technique or multiple instantiations of a mechanism unless noted otherwise. For example, a system may use a logic device, such as a processor, in a variety of contexts. However, it will be appreciated that a system can use multiple logic devices for similar purposes, while remaining within the scope of the present invention. Similarly, a host device, server, etc., may be described as performing various functions. In some implementations, a single device may perform such functions, whereas in other implementations the functions may be performed by multiple devices.

Furthermore, the techniques and mechanisms of the present invention will sometimes describe and/or illustrate a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, an indicated connection does not necessarily mean a direct, unimpeded connection unless otherwise noted. Moreover, there may be other connections between entities than are indicated herein, e.g., in network diagrams.

Overview

Some implementations of the invention involve methods and/or devices for providing real-time navigation data. Some such methods involve these steps: determining a location of a device; selecting at least one camera having a viewpoint that corresponds with the device location; obtaining video data from at least one selected camera; and displaying the video data on the device, according to the device location. The method may also involve aligning the video data with static images of objects near the device location and displaying the static images and the video data on the device.

The determining step may involve determining an actual device location and/or determining a virtual device location. If the determining step involves determining an actual device location, the determining step may involve reading a radio frequency identification (“RFID”) tag, e.g., an RFID tag associated with a mobile device. Alternatively, or additionally, the determining step may involve determining an actual device location via a triangulation technique and/or via the Global Positioning System (“GPS”) or the like. The determining step may involve analysis of an image, e.g., determining a device location relative to other objects in the image.

The method may also involve ascertaining a trajectory and/or an orientation of a mobile device and/or a patron. If so, the displaying step may involve displaying the static images and/or the video data on the mobile device according to a mobile device location, trajectory and/or orientation. The step of ascertaining a device trajectory may involve comparing a current device location with a past device location.

The step of ascertaining a device orientation may comprise determining an actual device orientation or a virtual device orientation. Similarly, the step of ascertaining a device trajectory may comprise determining an actual device trajectory or a virtual device trajectory.

If the ascertaining step comprises determining an actual device orientation, the ascertaining step may involve ascertaining a change in orientation with reference to at least one gyroscope. For example, the ascertaining step may involve ascertaining a change in orientation with reference to one or more gyroscopes, accelerometers, etc., disposed in a portable device. Alternatively (or additionally), the ascertaining step may involve ascertaining a change in device orientation via a directional receiver, such as a directional antenna.

If the determining step comprises determining a virtual device location, trajectory and/or orientation, the static images and the video data preferably correspond with the virtual location, trajectory and/or orientation. For example, the method may involve providing a virtual tour of an area by displaying static images and/or presenting video data corresponding to a sequence of virtual device locations and/or virtual device orientations.

Some implementations provide a portable device having one or more user interfaces that allow a user to control displayed navigation data. For example, a user may be able to control a display to “zoom in” to provide more details of a particular area. Similarly, a user may be able to control a display to “zoom out” to display a larger area. The displayed area may or may not correspond to the user's actual location. For “virtual” implementations, a user may be able to control a portable device to display desired virtual device locations, trajectories and/or orientations.

As noted elsewhere, many implementations described herein involve gaming establishments. In some such implementations, the displaying step may comprise displaying static images of gaming establishment elements, e.g., of gaming tables, wager gaming machines, bars, etc. The selecting step may comprise selecting at least one camera of a network of cameras in a gaming establishment.

Some implementations provide wagering games via the same mobile device on which real-time navigation data are displayed. In some such implementations, the mobile device may be operable in a “gaming mode” and a “navigation mode,” e.g., according to input received from a user. Even if the device is not configured to provide wager gaming, the device may be configured for a “sleep mode” and/or configured to be switched off from a navigation mode. Such implementations help to decrease the computational load and bandwidth requirements for devices not currently being used for navigational purposes.

The selecting step may sometimes involve selecting more than one camera of a network of cameras. If so, the obtaining step may comprise obtaining video data from each selected camera. The method may involve forming a composite image from the video data from each selected camera.

Some implementations of the method may also provide various techniques for aligning static images and video images. For example, the orienting step may involve aligning points and/or portions of at least one polygon in a static image with corresponding features in a video image.

The orienting step may also involve applying a mathematical transformation of video data taken from a camera viewpoint to produce video data from a device viewpoint. For example, the orienting step may involve applying a rotation matrix corresponding to a geometric rotation about a fixed origin. However, some implementations may avoid such a step, e.g., by selecting a camera that can provide images at approximately the same orientation as a mobile device.

Some such methods of the invention may also involve offering information, e.g., a benefit, corresponding with a device location. Such implementations may provide substantial opportunities, e.g., for targeting marketing and/or providing meaningful rewards to members of a player loyalty system.

### DETAILED DESCRIPTION

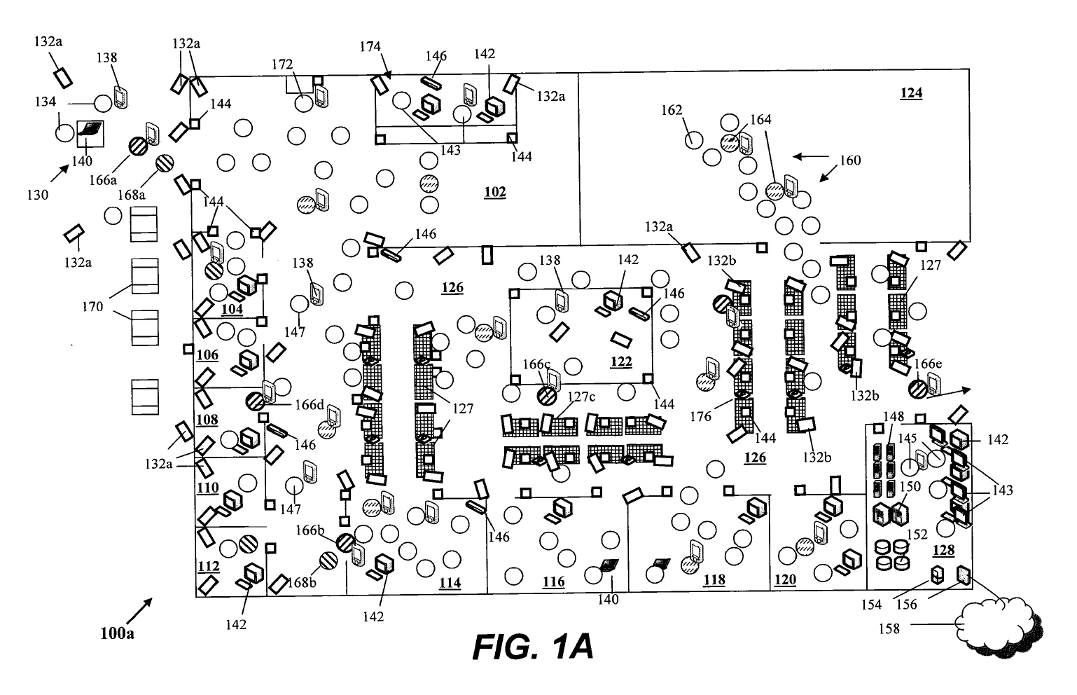

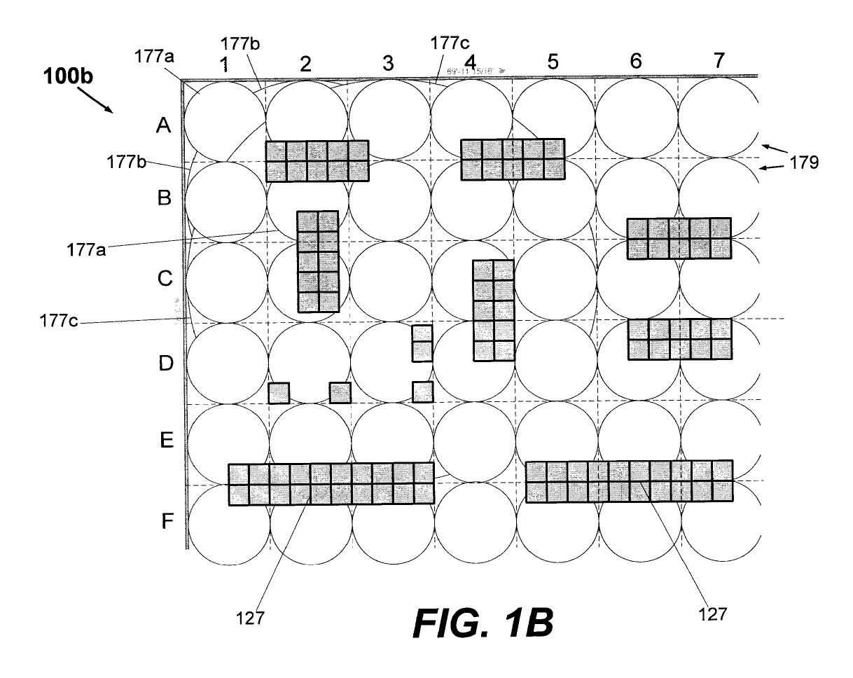

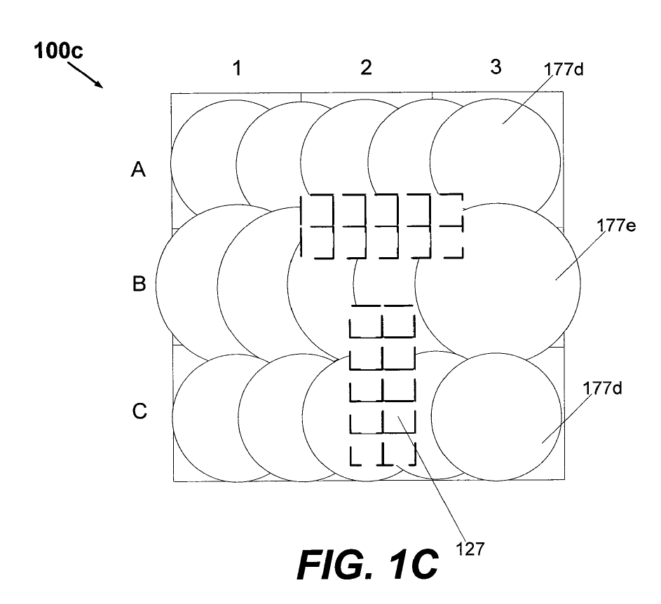

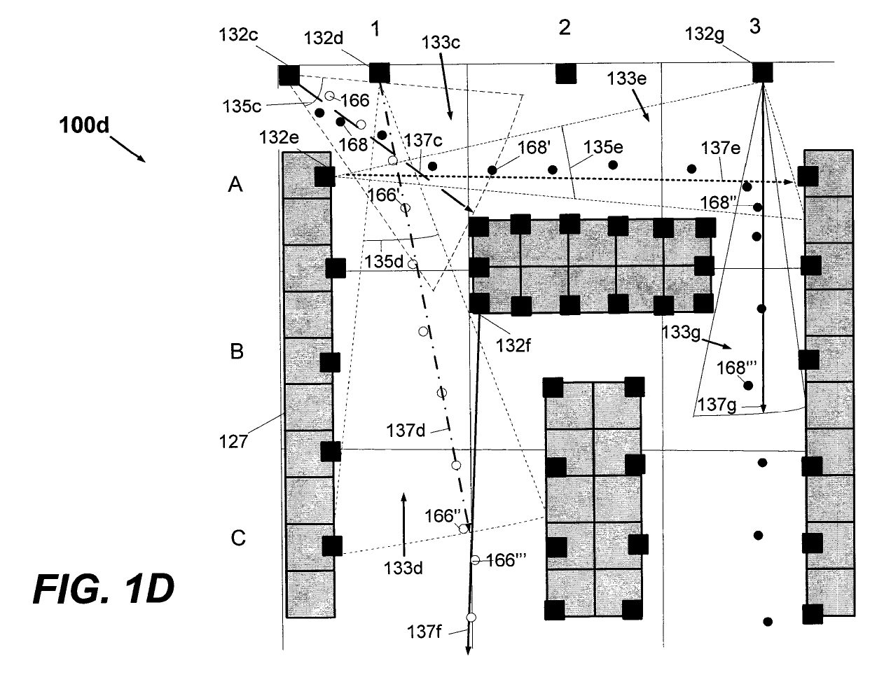

FIG. 1A depicts a simplified example of part of a casino configured for implementing some aspects of the invention. It will be appreciated the layout, the numbers and types of cameras, gaming machines and other devices, shops, etc. indicated in FIG. 1A are purely for the sake of example and that other layouts, etc., are within the scope and spirit of the invention. Some alternative layouts will be described below with reference to FIGS. 1B through 1D.

In this example, gaming establishment 100 includes valet area 130, lobby 102 and nearby shops 104, 106, 108, 110 and 112. These shops may include a range of retail establishments, including but not limited to souvenir shops, jewelry stores, clothing stores and the like. Food and beverage establishments 114, 116, 118 and 120 may include restaurants, bars, buffets, or any such dining and/or drinking establishment.

Bar 122 is an island in the midst of the main casino/gaming area 126 that includes various gaming machines 127. Preferably, at least some of gaming machines 127 are configured for communication with other devices, including but not limited to one or more of servers 148, in order to provide various features discussed elsewhere herein. Auditorium 124 includes a stage and seating (not shown) for live performances. At the moment indicated in FIG. 1A, a number of patrons 160 are exiting auditorium 124.

Operators 145 and various devices for providing services and managing gaming establishment 100 may be seen in control room 128. This area includes host devices 142 to facilitate the communication of operators 145 with various other devices, such as other host devices 142 (which may serve as cash registers, hotel registration terminals, etc.), mobile devices 138 (some of which may be cellular telephones, personal digital assistants [“PDAs”], iPhones™, portable wager gaming machines, etc.) laptops 140, gaming machines 127, etc. Host devices 142 may comprise desktop computers, laptops, workstations, or other such devices. Operators 145 may also communicate with other people, including but not limited to casino personnel 147, via mobile devices 138, telephones, etc.

Cameras 132a and 132b may be part of different networks or part of a common network. In some implementations, some of cameras 132 (e.g., cameras 132a) may be primarily (or exclusively) used for security purposes. Other cameras (e.g., cameras 132b) may be primarily (or exclusively) used for implementations of the present invention, e.g., for navigation and related functions. In some implementations, for example, cameras 132a may be primarily used as security cameras but may be used, under certain conditions, to implement navigation-related features of the present invention. Likewise, cameras 132b may be primarily used to implement navigation-related features of the present invention but may also be used as security cameras, under predetermined conditions.

Likewise, casino security functions as well as functions specific to the present invention may be performed (at least in part) by devices and/or people in control room 128. However, in alternative implementations, the security personnel and/or devices may be located in a separate location. Moreover, as described below, some implementations involve communications between a gaming establishment and other locations, e.g., communications between a gaming establishment and a central system and/or communications between gaming establishments.

Accordingly, host devices 142, cameras 132 and other devices, as needed, may be configured for communication with servers 148, computing devices 150, storage devices 152, etc. Some such devices may also be configured for communication with one or more external networks 158, in this example via gateway 154 and firewall 156. Network 158 is the Internet in this example, but in other implementations network 158 may comprise one or more other public or private networks. According to some implementations of the invention, additional storage devices and related devices may be accessed via network 158, e.g., a storage area network (“SAN”) or other types of network storage.

Control room 128 includes a plurality of monitors 143 for, inter alia, receiving image data from cameras 132. Cameras 132 may include, for example, “smart cameras,” closed circuit television (“CCTV”) cameras, closed circuit digital photography (“CCDP”) cameras, range cameras and/or webcams. Accordingly, the image data displayed on monitors 143 may include still digital images, video feeds, freeze-frames, etc. Such image data may be used for various purposes, including not only security purposes known in the art but also for various implementations of the present invention, as described in more detail elsewhere herein.

Servers 148 and/or computing devices 150 may be configured to perform various functions, including but not limited to image processing functions, device and/or patron location functions, navigation functions, player loyalty functions, patron identification functions (including but not limited to biometric functions such as facial recognition functions), licensing, gaming, accounting, security services, etc. These functions may include those known in the art and those specific to the present invention. At least some of servers 148 may be configured for communication with cameras 132 and/or other devices (such as host devices, mobile devices 138, RFID readers 144, gaming machines, kiosks, gaming tables, etc.), in order to provide real-time device location functionality, imaging functionality, navigation functionality and/or other methods described herein.

Some implementations of the invention may involve computer vision, machine vision and/or facial recognition systems. For example, some implementations of the invention leverage the ability of smart cameras. A smart camera is an integrated machine vision system which, in addition to image capture circuitry, normally includes a processor configured to extract information from images without the need for an external processing unit. A smart camera generally includes an interface system for communication with other devices. Some smart cameras can identify physical characteristics of individuals, even in a crowd, and track identified individuals as they move through the crowd.

For example, Tyxz, Inc. announced on Dec. 19, 2006 that its DeepSea™ G2 Vision System was able to successfully track visitors to an exhibit at the Smithsonian's Cooper-Hewitt National Design Museum in New York City. The DeepSea™ G2 Vision System may be configured for communication with other devices (e.g., other cameras, devices in control room 128, etc.) via TCP/IP.

Accordingly, such smart cameras can provide useful data for implementing some aspects of the present invention. For example, a smart camera may be configured to recognize and track a patron who is using a portable navigation device of the present invention. Such a camera may be able to determine and/or to verify a patron's location, orientation and/or direction of travel. Accordingly, a smart camera may also be configured to determine, at least in part, which camera(s) should provide video data to a portable device, when to “hand off” from one camera to another as a patron moves, etc.

Computing devices 150 may be desktop computers, workstations, blade servers, mainframe computers, supercomputers or other such devices. The type and number of computing devices 150 may be selected according to the speed and number of calculations and other processes that will be required of them. For example, one or more of computing devices 150 (or other devices) may be used for processing image data from cameras 132 (such as calculations for making a correspondence between static images and video images, calculations for transforming image data from a camera perspective to a device and/or patron perspective, etc.), for calculations involved in patron location, patron preference determinations, making a correspondence between patron locations and patron preferences, etc.

In some implementations, each of the camera units may be remotely configured, e.g., by one or more devices of control room 128. In some such implementations, all camera units of a similar type may share the same rules and parameters. However, this need not be the case. Particularly when the cameras are individually addressable, specific rules and parameters can be applied as necessary. For example, certain cameras may record data only when addressed, at specific times or when specific thresholds were reached, such as when at least a threshold number of moving objects (e.g., three or more) are in view. Preferably, all camera units will use consistent time codes to insure that data obtained from different cameras can be meaningfully combined.

In some implementations, selective compression may be automatically applied to the images so that the data transmission requirements are reduced. For example, the system may apply minimal compression to floor areas where players or other people appear (or are likely to appear) and higher levels of compression to static and/or background areas of the image.

In the example illustrated in FIG. 1A, a plurality of radio frequency identification (”RFID”) readers 144 are disposed in various locations of gaming establishment 100. RFID readers 144 and related devices may be used to determine the location of a mobile device 138 that includes an RFID tag, etc. Further examples of how RFID readers 144 and related devices may be used according to the present invention are described elsewhere herein.

Accordingly, some of network devices 146 may be switches, middleware servers and/or other intermediate network devices in communication with RFID readers 144 and at least one of servers 148 that may be configured to provide RFID functionality, such as patron identification and/or location functionality. Depending in part on the size of the gaming establishment(s) involved, the number of RFID readers, etc., it may be advantageous to deploy various RFID-related devices at various hierarchical levels of an RFID network, which may include devices outside of gaming establishment 100. Some such devices and networks are described in “The EPCglobal Architecture Framework: EPCglobal Final Version of 1 Jul. 2005,” which is hereby incorporated by reference. Some network devices 146 may comprise wireless access points for providing a communication link with wireless devices, including but not limited to mobile devices 138.

Moreover, one or more of servers 148 (and/or other devices) may be configured to synthesize various types of patron data. For example, one of servers 148 may be configured to determine whether a “read” from an RFID player loyalty device, from an RFID tag on a mobile device, etc., corresponds with the location (and/or identification) of a particular patron whose activities correspond with a defined event of interest to the casino. The server (or another device) may cause offers that correspond with the indicated location to be sent to a mobile device. In some such implementations, the offers may be selected to correspond with patron preference data, e.g., by reference to a database of a player loyalty system.

Other casinos may or may not have RFID readers and/or an associated RFID network. However, most aspects of the present invention can be implemented regardless of whether a casino has these features. For example, a device (e.g., a server) may determine a mobile device and/or patron location in other ways, e.g., by using signal strength detection between known locations to determine a mobile device location by triangulation (e.g., 802.11 triangulation). Some mobile devices may be configured for providing locations according to the Global Positioning System (“GPS”) or the like.

Other implementations may involve determining a mobile device location and/or a patron location by making a correspondence between a known location and an image of the location, e.g., making a correspondence between a known location of a feature in a casino (e.g., of a gaming machine) and an image of the feature that the patron is observed to be near. Some such implementations may involve image recognition and/or image tracking by a smart camera or other device.

Alternatively, or additionally, an operator (or a device, such as a smart camera) could make a correspondence between a patron of interest and an area of a map grid, e.g., a grid displayed on a display screen and superimposed on an image of the casino floor (e.g., an overhead view). In one such example, an operator may indicate a patron of interest by touching an area of a touch screen corresponding to the patron and the location. Relevant devices and methods are described in U.S. patent application Ser. No. 11/844,267 (attorney docket no. IGT1P408/P-1221), entitled “Multimedia Player Tracking Infrastructure” and filed on Aug. 23, 2007, which is hereby incorporated by reference for all purposes.

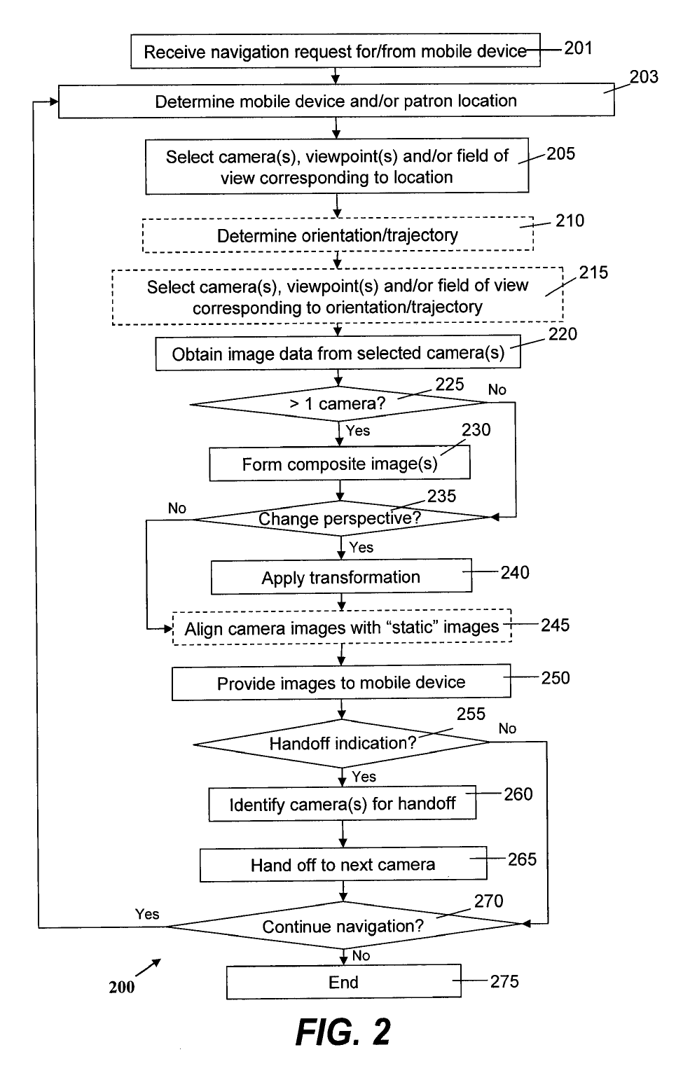

FIG. 2 depicts flow chart 200, which will now be referenced to describe some implementations of the invention. As with other implementations described herein, such implementations may include more (or fewer) steps than are indicated. Moreover, the steps of such implementations are not necessarily performed in the order indicated. The steps of the methods described herein are preferably performed automatically, e.g., by servers, host devices, smart cameras, mobile devices, etc., in a network.

In this example, the process begins when a navigation request is received pertaining to a mobile device. (Step 201.) The mobile device may be, e.g., one of mobile devices 138 depicted in FIG. 1A. Other examples and details regarding mobile devices that may be used to implement some aspects of the invention are provided below. Here, a mobile device may be configured to provide real-time navigation features on demand. For example, a user may interact with a user interface (such as described below) to initiate a session of real-time navigation.

In some such implementations, the mobile device may be used for one or more other purposes, e.g., for wager gaming. If, for example, a patron does not desire real-time navigation features at a particular time (e.g., because the patron is using the mobile device for another purpose, is not using the mobile device at all, etc.), then there may be no point to continue providing real-time navigation features. Accordingly, some mobile devices may be configured to start and/or stop providing real-time navigation features under certain conditions, e.g., in response to user input, according to whether the mobile device is being used for wager gaming, etc.

Alternatively, real-time navigation features may be provided whenever a mobile device is powered on, whenever the mobile device is powered on and is moving, etc. However, such implementations may consume resources unnecessarily, at least some of the time.

Accordingly, step 201 may involve one or more devices of a navigation system receiving a signal from a mobile device. There may be additional steps of authentication, determining a class of service/features to be provided (e.g., according to a patron's rank in a player loyalty system), etc., that are not indicated in FIG. 2. For example, mobile devices having different levels of functionality may be provided to patrons according to the patrons' ranks in the player loyalty system. Alternatively (or additionally), the mobile device may transmit a patron's player loyalty code along with the navigation request. Real-time navigation services may be provided according to the patron's preferences, rank, etc., as determined by reference to a player loyalty database. Some examples of providing customized navigation services according to a patron's preferences are described in more detail below.

In step 203, the mobile device's location and/or the patron's location is determined. The location may be an actual location or a virtual location. For example, a virtual location may be determined according to user input received by a mobile device and transmitted to a device of a system for providing real-time navigation data. Alternatively, a virtual location may be determined according to a software routine for providing a “virtual tour” of a casino or other area.

Actual locations may be determined in a variety of ways. In the example illustrated in FIG. 1A, an actual location may be determined by reference to one or more RFID devices. For example, a plurality of radio frequency identification (“RFID”) readers 144 are disposed in various locations of gaming establishment 100. RFID readers 144 and related devices may be used to determine the location of a mobile device 138 that includes an RFID tag, etc. For example, if a single RFID reader reads an RFID tag associated with a mobile device, the location of that RFID reader may be temporarily associated with the mobile device. If more than one RFID reader is reading an RFID tag associated with a mobile device, the location of the RFID reader that is obtaining the strongest signal may be temporarily associated with the mobile device.

Similarly, RFID readers 144 and related devices may be used, for example, to read and determine the location of another RFID device associated with a patron who is using a mobile device. Such an RFID device may be a dongle, a bracelet, a “smart card” (which may serve as a player loyalty and/or player tracking card) or another such RFID device. The patron's location may be inferred from the location of the location of the patron's RFID device.

In alternative implementations, a mobile device 138 may include an RFID reader. The RFID reader may, for example, be configured to read RFID tags affixed to various locations. The RFID tags may be encoded with location information, such that when the RFID reader reads an RFID tag, the corresponding location and/or associated information may be indicated. In some such implementations, the location information may be obtained indirectly from the RFID tag data, e.g., by comparing an RFID tag code read by the RFID reader to corresponding location data in a database.

Alternatively, or additionally, step 203 may involve determining a device location via a triangulation technique and/or via the Global Positioning System (“GPS”) or the like. Step 203 may involve analysis of an image, e.g., determining a patron location and/or a device location relative to other objects in the image. In some implementations, one location method may be used as a “cross-check” for another method, e.g., to determine whether a location determined by reference to an RFID tag read corresponds to a location determined according to image analysis. A location determined according to image analysis may provide a more precise location of a patron and/or device than an RFID-based location method (e.g., by reference to a map grid or other coordinate system), but may be more subject to errors in reliably tracking the correct person or device (e.g., during crowded conditions).

In step 205, one or more cameras are selected that have a viewpoint corresponding to the mobile device location. The mobile device's trajectory and/or orientation may also be determined. (Step 210.) If so, the camera(s) may be selected according to the mobile device trajectory and/or orientation. (Step 215.) Image data are obtained from the selected cameras. (Step 220.)

Various implementations will be described herein for making a correspondence between one or more cameras of a camera network and a mobile device location, trajectory and/or orientation. Some simple examples will be described with reference to FIGS. 1B and 1C. These simple examples do not require changing a camera perspective to a device and/or patron perspective.

More complex examples will be described thereafter. Some such examples involve determining a mobile device and/or patron trajectory. Some such examples involve determining a mobile device orientation. Some such examples involve obtaining data from more than one camera (step 225) and forming a composite image of these data (step 230). Some such examples involve determining whether to change a camera perspective to a device and/or patron perspective (step 235) and, if so, applying a transformation to camera images to obtain the device and/or patron perspective (step 240).

The first example involves obtaining image data from a series of cameras and “hand offs” from one camera to another according to a mobile device and/or patron location. FIG. 1B provides a top view of system 100b, which includes a plurality of networked cameras in a portion of a casino. This view may be, for example, presented on a display of one or more devices indicated in FIG. 1A (e.g., one of host devices 143 in control room 128 of FIG. 1A). Here, the smaller squares with darker outlines represent a number of gaming machines 127, which are depicted in various configurations.

System 100b preferably includes as many independent camera units as necessary to cover the desired area. Here, each camera has at least one associated field of view 177. The camera units may comprise still or video cameras, but preferably at least some of the camera units comprise video cameras. Some such camera units may include a video camera, one or more logic devices (e.g., processors), local data storage and network communications capabilities. However, the configuration and distribution of the camera units may vary depending on the implementation. For example, the camera units described with reference to FIGS. 1B and 1C have a “top down” orientation, whereas the camera units described with reference to FIGS. 1A and 1D have a variety of camera orientations.

In addition to cameras and gaming machines, system 100b includes the necessary network devices, host devices, location determining devices (e.g., networked RFID readers or the like), one or more servers, etc., such as those described above with reference to FIG. 1A and/or those described below. Such devices may be configured, inter alia, to locate mobile devices and/or patrons, to coordinate the activities of the camera units and to perform other methods described herein. However, neither the cameras themselves nor these other details are depicted in FIG. 1B, in order to focus attention on the interplay between camera fields of view and corresponding areas of the casino.

In this simple example, the indicated portion of a casino has been divided into a plurality of cells 179 of approximately equal size. The cells 179 may or may not be presented on a display device. It will be apparent to those of skill in the art that the casino itself may not necessarily include physical manifestations of the cells 179.

Here, each of the cells 179 is further identified according to its position in system 100b. In this example, each row has been assigned a corresponding letter and each column has been assigned a corresponding number. In this way, each of cells 179 can be uniquely identified according to a combination of a letter and a number, e.g., as cells A1, B1, etc. However, it is not essential that a grid or other coordinate system be employed; any convenient manner of identifying areas of the casino may be used. If a grid-type coordinate system is used, it is convenient, but not essential, that the cells be the same size.

In the example depicted in FIG. 1B, each of the camera fields of view 177 is centered on a grid cell and may be identified as such. Each of the camera fields of view 177a is approximately coextensive with a corresponding cell 179 of system 100b.

In some preferred implementations, at least some of the camera field of view areas 177 overlap grid cell boundaries. This may be desirable for several reasons, e.g., in order to prevent blind spots. Another advantage may be seen with reference to fields of view 177b and 177c of FIG. 1B. Field of view 177b is centered on grid cell B2 and has a diameter of approximately 3 grid cells. Field of view 177c is centered on grid cell C3 and has a diameter of approximately 5 grid cells. Larger fields of view may be desirable to display a larger part of a casino. Moreover, as noted below, such larger fields of view may require less frequent “hand offs” from one camera to another.

Whereas FIG. 1B indicates that most camera fields of view are of the 177a type, this representation has been made primarily for ease of illustration. In practice, there may be more of the larger fields of view than the smaller fields of view, the same number, or fewer. Moreover, a single camera may be used to provide a range of fields of view, e.g., by selecting an angular range. For example, a camera in grid cell B2 may provide image data corresponding to grid cell B2 (field of view 177a) or corresponding to more than one grid cell (e.g., field of view 177b).

However, in some implementations, a smaller field of view may correspond with a different camera focal length and/or degree of magnification. For example, fields of view 177a may provide enlarged views as compared to fields of view 177b or 177c. Some such implementations allow a patron to control a mobile device to select a field of view, e.g., to “zoom in” or “zoom out.” For example, a patron may control a mobile device to select field of view 177a, 177b, 177c or some other field of view. Similarly, an operator may select a field of view to be provided by one or more cameras. It will be appreciated that larger or smaller camera fields of view may be provided than are shown or described herein.

In some preferred implementations, each camera has its own identification (“ID”) code, which may be a numerical code, an alphanumeric code, or the like. A camera ID code may reference a location, either directly or indirectly. For the layout depicted in FIG. 1B, for example, cameras and/or fields of view may be identified (at least in part) according to the row and column of the corresponding cell, e.g., as cameras and/or fields of view A1 though F7. Therefore, in one simple example, each camera ID may corresponds to one of cells 179, which in turn represents an area of the physical floor layout.

In some implementations, the camera ID codes may reference location data (such as grid cell data), but may include additional information. In some implementations, for example, there may be more than one camera and/or field of view corresponding with a grid cell. For example, there may be 5 cameras located within grid cell B2. Such cameras and/or fields of view may be referenced, for example, as B2A through B2E, as B2.1 through B2.5, or the like. For example, B2A may reference field of view 177a, whereas B2B may reference field of view 177b. As noted above, these fields of view may or may not correspond to the same camera.

In other implementations, such as depicted in FIGS. 1C and 1D, cameras and/or fields of view are not necessarily centered within a grid cell. Similarly, fields of view do not necessarily have diameters that are integral multiples of grid cells.

FIG. 1C illustrates an example of a system 100c of networked camera units that have overlapping fields of view 177. In this example, the fields of view 177d are approximately the same size and have diameters of approximately 1 grid cell. However, unlike fields of view 177a, fields of view 177d overlap along each row. In either case, the labels of cells 179 may be used to identify uniquely each field of view. For example, the top row of fields of view could be identified as A1, A1.5, A2, A2.5 and A3. In some implementations, similar overlaps may be made along each column.

Here, the fields of view 177d of rows A and C are approximately the same size. However, the fields of view 177e of row B are larger than fields of view 177a or fields of view 177c. This configuration allows the fields of view 177d to overlap not only with fields of view 177b in the same row, but also with fields of view 177d in adjacent rows.

Even though the fields of view 177b extend beyond the corresponding cells in row B, the cameras and/or fields of view may still be identified in a manner such as that described above. Here, for example, the cameras and/or fields of view in row B could be identified (at least in part) according to the location of the center of each field of view 177e, e.g., as B1, B1.5, B2, B2.5 and B3.

As described in more detail below, mobile devices and/or casino patrons may also be assigned an ID code, which may or may not correspond with a player loyalty account number. Other elements of the casino may also be assigned ID codes. Here, each gaming machine is also assigned an unique ID, though the ID is not shown. In the simple example depicted in FIG. 1B, step 205 of flow chart 200 may involve making a correspondence between a mobile device and a grid cell. When it is determined (in step 203) that a mobile device that is currently located within a particular grid cell, a camera and/or field of view corresponding to that grid cell will be selected in step 205. As with other implementations described herein, the location determination of step 203 may involve determining an actual location or a virtual location. Any convenient method of locating the mobile device may be used. For example, methods of determining an actual location may include, but are not limited to, the RFID-based methods, the GPS-based methods and triangulation-based methods described elsewhere herein.

As noted above, however, there may be more than one camera and/or field of view corresponding to a grid cell. If, for example, the mobile device is determined to be located within grid cell B2, field of view 177a, 177b or 177c may be selected. Moreover, there may be additional fields of view associated with grid cell B2 that are not indicated in FIG. 1B. In some implementations, the selection may be made by a server or other device of a central system that is supporting real-time navigation functionality. For example, the selection may be made according to the field of view most recently provided to a mobile device, in order to provide a consistent field of view type for a viewer. The selection may be made according to an indication from the mobile device itself. Image data from the corresponding camera will be obtained. (Step 220.)

The selecting step may sometimes involve selecting more than one camera of a network of cameras. If so, the obtaining step may comprise obtaining video data from each selected camera. The method may involve forming a composite image from the video data from each selected camera. However, because in this example image data from only one camera are obtained in step 220, it will be determined in step 225 that no composite images need to be formed. (Step 230.)

In step 235, it is determined whether to apply a mathematical transformation of video data taken from a camera viewpoint to produce video data from a mobile device viewpoint. For example, the orienting step may involve applying a rotation matrix corresponding to a geometric rotation about a fixed origin. However, some implementations may avoid such a step, e.g., by selecting a camera that can provide images at approximately the same orientation as a mobile device. Similarly, this “eye in the sky” example does not involve making a correspondence between a camera viewpoint and a mobile device viewpoint, so it is determined in step 235 that no perspective change is required.

Other implementations of the method may provide various methods of aligning static images and video images. (Optional step 245, examples of which are described below.) However, this simple example does not require making a correspondence between camera images and “static” images of casino features such as gaming machines 127. In this example, camera images (here, video camera images) from an indicated grid cell (e.g., cell Al) are provided to a mobile device currently located in that grid cell. (Step 250.) However, in alternative examples, the camera images may be superimposed upon static images, or vice versa.

Images from the same camera will continue to be provided to the mobile device so long as there is no handoff indication (as determined in step 255) and so long as the mobile device is configured to continue providing real-time navigation functionality.

A wide variety of hand-off indications are contemplated herein. For example, hand-off indications may be based upon a mobile device location, a patron location, a mobile device and/or patron trajectory, a mobile device and/or patron orientation, etc. A hand-off indication may be based upon input from a mobile device, e.g., a request for a larger field of view, an indication that a mobile device orientation has changed, etc. A hand-off indication may be provided by a server or other networked device, based on various inputs and/or criteria. For example, a hand-off indication may be determined as part of providing a virtual tour of a casino. In some implementations, a hand-off indication may be based upon a determination that another camera would provide a better view, whether because a first camera's view is obscured, because a second camera is closer, because the first camera is being used for another purpose (e.g., for zooming in on a patron of interest), etc.

Some examples of hand-off indications and other issues will now be described with reference to FIG. 1D. FIG. 1D illustrates a portion of a casino 100d, which includes a number of wager gaming machines 127 and networked cameras 132. Cameras 132 may or may not all be the same type of camera. In one example, at least some of the cameras 132 may provide more functionality than others. For example, some cameras (e.g., cameras 132d and 132g) be relatively higher-resolution cameras, may be “smart” cameras configured for patron recognition and/or tracking, may be capable of zooming in or out, etc.

In this example, many of the cameras 132 that are mounted on wager gaming machines 127 are relatively inexpensive “webcams,” which may be digital cameras with an associated logic system (e.g., one or more processors). Webcam software executed by the logic system “grabs a frame” from the digital camera at a preset interval and transfers it to another location for viewing. For streaming video, a webcam system should have a relatively a high frame rate, e.g., at least 15 frames per second and preferably 30 frames per second.

After it captures a frame, the camera software may transfer the image on a network. For example, the software may convert the image into a JPEG file and upload the image to a server using File Transfer Protocol (“FTP”). In some implementations, some type of data compression method (e.g., a compression method such as one provided by a Moving Picture Experts Group [“MPEG”] standard, such as MPEG4) may be used to achieve true streaming video.

Here, patron 166 is a valued member of the casino's player loyalty program and has been provided with a mobile device configured for providing some real-time navigation functionality according to the present invention. Companion 168 was not previously known by the casino, but has also been provided with a mobile device configured for providing real-time navigation functionality.

In this example, each mobile device has a mobile device code. Each mobile device code is associated with a patron to which a mobile device is assigned. Here, the mobile device code for the mobile device provided to patron 166 is associated with the player loyalty account code for patron 166. A new code is created for companion 168 and associated with the mobile device code for the mobile device provided to companion 168.

In the example depicted in FIG. 1D, patron 166 and companion 168 are shown in a series of locations in casino portion 100d. The locations of patron 166 are depicted as a series of empty circles and those of companion 168 as a series of black circles. Patron 166 and companion 168 enter casino portion 100d in the upper left portion of FIG. 1D, in grid cell A1 just above the row of wager gaming machines 127. While in grid cell A1, patron 166 and companion 168 decide to head in different directions for a while. Initially, patron 166 continues along column 1 (see subsequent locations 166′ and 166″) and companion 168 continues along row A (see subsequent locations 168′ and 168″). Later, companion 168 changes direction and proceeds along column 3 (see subsequent location 168′″).

In this implementation of the invention, the mobile devices carried by patron 166 and companion 168 provide real-time navigation information according to location and trajectory. This implementation will now be described by reference to various figures, including FIGS. 1D, 2, 3A and 3B.

Referring now to FIG. 2, patron and/or device locations are determined in step 203. The locations of patron 166 and companion 168 are determined, in this example, according to the locations of their respective mobile devices. Accordingly, a patron's location may sometimes be referenced herein as equivalent to a mobile device location. For example, a patron's location may sometimes be referenced when a mobile device location has actually been determined (and vice versa). As described elsewhere, the location determination may be made in any convenient fashion, e.g., by reference to RFID tags, devices (such as RFID readers) in an RFID network, via triangulation, according to another positioning system such as GPS, etc.

For example, each one of cameras 132 may have an associated RFID device. The RFID device may comprise an RFID reader that is configured to read RFID tags disposed on mobile devices. The RFID tags may include a code that is associated with each mobile device. A mobile device location may be determined according to the location of an RFID reader that is reading the mobile device's RFID tag. If more than one RFID reader is reading the mobile device's RFID tag, the strongest signal may be used to determine the nearest RFID reader location.

Alternatively, mobile devices may be equipped with one or more RFID readers. RFID tags may be positioned at various locations, e.g., including but not necessarily limited to camera locations. The mobile device location may be determined according to the RFID tag that is read by a mobile device. For example, a server or other device may receive a code corresponding to an RFID tag read by a mobile device. The device may determine the mobile device location, e.g., by reference to a database of RFID tag codes and corresponding locations.

In step 205, one or more cameras, viewpoints and/or fields of view are determined according to the location. In this example, a subset of possible cameras is determined in step 205 and at least one camera is later selected (in step 215) according to a determined trajectory and/or orientation (step 210). Here, trajectories are determined by comparing a first location with a second location, e.g., by comparing a current mobile device location with a previous mobile device location.

It will be appreciated that the steps of selecting camera(s), viewpoint(s) and/or field(s) of view may be performed in a single operation rather than in two separate steps. For example, a single step of selecting camera(s), viewpoint(s) and/or field(s) of view may be performed after determining both location and trajectory.

Referring again to FIG. 1D, this selection process will be described in greater detail. As noted above, the cameras 132 depicted in FIG. 1D may have different capabilities. Moreover, cameras 132 may have a variety of orientations, may be deployed at different heights and/or in locations that provide different viewing opportunities. It will also be appreciated that in a casino environment, a camera's view may be obscured by static features (such as gaming machines, gaming tables, walls, bars, etc.) or dynamic features (such as patrons).

In the example shown in FIG. 1D, each camera 132 has at least one associated area 133. Here, each area 133 has been previously determined to be an optimal area for providing images from the corresponding camera. The area may be selected, for example, based on the camera's orientation, elevation, focal length (if static) and/or field of view, etc. In this example, each area 133 is associated with the corresponding camera 132 in a database.

In this example, each area 133 is an area of a circle, defined by an angle range 135 and a radius 137. For example, area 133c is defined according to angle 135c and a corresponding radius 137c. Similarly, areas 133d and 133e are defined according to angles 135d and 135e, as well as by corresponding radii 137d and 137e.

Information regarding each area 133, angle range 135 and radius 137 is preferably associated with a corresponding camera and stored in a data structure. In some implementations, areas 133, angle ranges 135 and/or radii 137 may be displayed, e.g., on a display device used by an operator of a real-time navigation system. For example, an operator may select a particular camera 132 (e.g., by touching a screen, by a mouse click, etc.) and be provided with a menu of options, one of which is to display the corresponding area 133, angle range 135 and/or radius 137.

If, for example, a mobile device is determined to be located within area 133c and to be moving along a trajectory that approximates one of the radii within area 133c, step 215 may involve selecting camera 132c. Accordingly, when patron 166 and companion 168 are determined to be located within area 133c and determined to be moving along a trajectory that approximates radius 137c, step 215 of FIG. 2 comprises selecting camera 132c. Image data from camera 132c are obtained in step 220. In this example, it is then determined that image data have been obtained from only one camera (step 225 of FIG. 2).

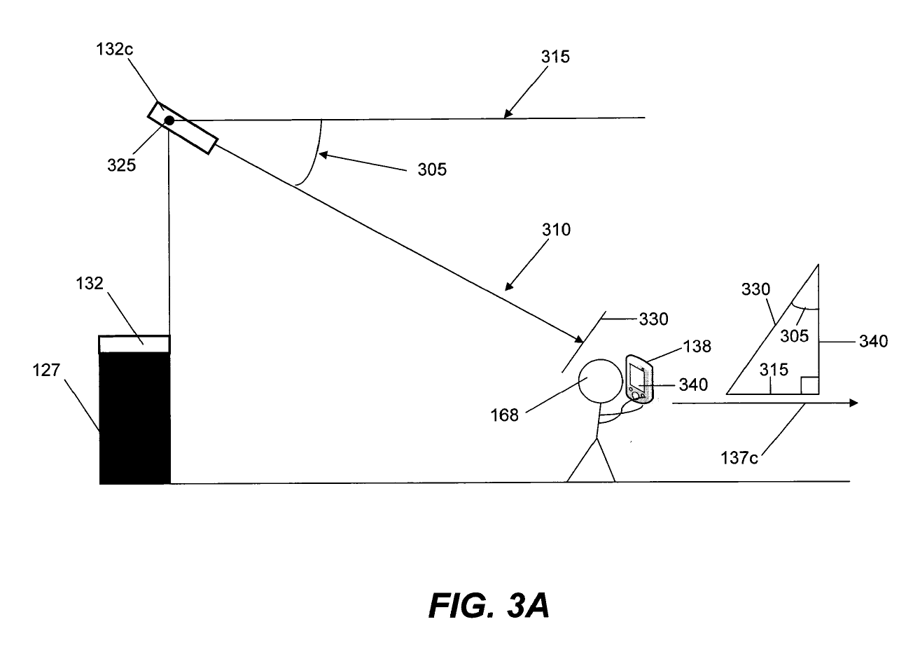

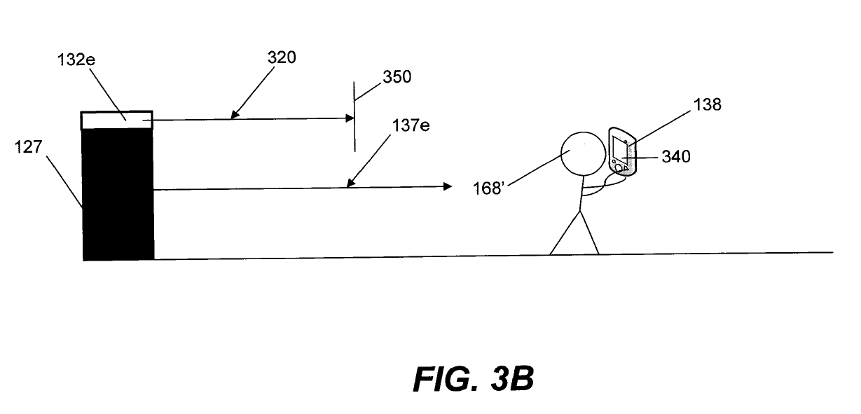

In step 235, it will be determined whether to change the perspective/viewpoint of the image data received from camera 132c. As shown in FIG. 3A, camera 132c is deployed at a higher elevation than some other cameras 132, e.g., those that are mounted on wager gaming machines 127. Accordingly, there is an angle 305 between camera viewpoint 310 of camera 132c and mobile device viewpoint 315. Here, mobile device viewpoint 315 corresponds with trajectory 137c (see FIG. 1D), so that the image provided on mobile device 138 is an image of that portion of the casino towards which a mobile device is moving.

Therefore, it is determined in step 235 that the images from camera 132c should be transformed from a camera perspective to the mobile device perspective. Accordingly, in step 240 the image data from camera 132c are transformed. The transformation may be made according to any convenient method, including mathematical transformations and/or optical transformations.

For example, the orienting step may involve applying a rotation matrix corresponding to a geometric rotation about a fixed origin. A plane projective transformation, also known as a plane to plane nomography, may be used to map points in a first plane (e.g., image plane 330 of camera 132c) to another plane (e.g., image plane 340 of mobile device 138). Relevant information is presented in A. Criminisi, I. Reid and A. Zisserman, A Plane Measuring Device (Department of Engineering Science, University of Oxford, 1997), which is hereby incorporated by reference.

Step 240 may be relatively more or relatively less complex, according to the implementation. For example, in some implementations, the actual orientation of a mobile device is used to determine the image plane into which the image data from camera 132c are transformed. According to some such implementations, this orientation may be determined according to one or more devices within the mobile device itself, such as accelerometers, gyroscopes, or the like. In one such implementation, the mobile device includes a triple-axis gyroscope system that can detect changes in x, y or z orientation of the mobile device.

In another implementation, a mobile device orientation may be determined via a directional transmitter and/or receiver, e.g., by detecting a beam (such as a light beam [e.g., a laser beam], a radio signal, etc.). In some such implementations, the beam is emitted from a transmitter (preferably a directional transmitter) of the mobile device. In alternative implementations, the beam is detected by a receiver (preferably a directional receiver) of the mobile device.

Some implementations that involve determining the actual orientation of a mobile device may use such orientation information for other purposes. For example, device orientation information may be used as part of the handoff determination process of step 255. In some such implementations, a handoff determination may be made independently of mobile device trajectory. For example, even if a mobile device remains in approximately the same location, a detected change in mobile device orientation may trigger a handoff to another camera that provides a corresponding perspective.

Suppose a mobile device were determined to be within area 133c, area 133d and area 133e. In some implementations, if the mobile device's orientation were determined to correspond with the perspective of camera 132e, image data from camera 132e may be provided to the mobile device regardless of whether the mobile device were moving along trajectory 137e, moving along some other trajectory or remaining in approximately the same location. If the mobile device were then re-oriented to correspond with the perspective of camera 132d, image data from camera 132d may be provided to the mobile device regardless of the mobile device's trajectory.

However, some implementations provide simpler and less computationally intensive methods for determining the orientation of a portable device. In some such implementations, the orientation of a portable device is inferred, e.g., according to the last known trajectory of the mobile device. For example, the image plane into which the image data from camera 132c are transformed may be a plane corresponding to trajectory 137c, e.g., having a normal that is parallel to trajectory 137c.

Similarly, the algorithm used for the transformation from a camera perspective to a mobile device perspective may be a relatively simpler algorithm or a relatively more complicated algorithm. In some implementations, a relatively complex algorithm such as described in A Plane Measuring Device may be used in step 240. In alternative implementations, a simple trigonometric approach may be involved. For example, if the mobile device image plane is determined according to a mobile device trajectory (e.g., is determined to be perpendicular to trajectory 137c, as shown in FIG. 3A), step 240 may involve applying a simple trigonometric formula to lengthen or shorten the distance between points in an image.

One such example is depicted in FIG. 3A. Here, image plane 340 of the mobile device is assumed to be perpendicular to trajectory 137c. Image plane 330 of camera 132c is at an angle 305 from image plane 340. Accordingly, in one implementation, step 240 involves shortening distances between points along the vertical axis of image plane 340 by multiplying the corresponding distances by the cosine of angle 305.

However, some implementations may avoid such a transforming step, e.g., by selecting a camera that can provide images from approximately the same perspective/point of view as a mobile device. This is one advantage of mounting cameras 132 at a height comparable to that of an expected elevation of a mobile device, e.g., by mounting cameras 132 on wager gaming machines 127.

Referring again to FIG. 1D, when patron 168 reaches position 168′, it is determined that patron 168 is near the edge of area 133c. It is also determined that the trajectory of patron 168 is changing. One or both of these indicia may comprise a handoff indication (as determined in step 255) and therefore another camera is identified in step 260.

Here, it is determined that patron 168 has a trajectory 137e that approximates one of the radii of nearby camera 132e and that patron 168 is within corresponding area 133e. Therefore, camera 132e is selected in step 260. Image data will continue to be obtained from camera 132e as long as patron 168 remains within area 133e and continues substantially along trajectory 137e.

However, as depicted in FIG. 3B, camera viewpoint/perspective 320 is substantially parallel to trajectory 137e, which is presumed to correspond with the viewpoint of mobile device 138 in this example. In other words, the image plane 350 of camera 132e is presumed to be approximately parallel to image plane 340 of mobile device 138. Therefore, in this example it is determined in step 235 that there is no need to change the perspective of the image data received from camera 132e from a camera perspective to a mobile device perspective.

In this example, when patron 168 reaches 168″, it is determined that patron 168 is near the edge of area 133e and has changed trajectory. This is a handoff indication (as determined in step 255) therefore another camera is identified in step 260. Here, it is determined that patron 168 has a trajectory 137g that approximates one of the radii of camera 132g and that patron 168 is within corresponding area 133g (not shown). Therefore, camera 132e is selected in step 260.

In this example, camera 132g is mounted at a height comparable to that of camera 132c. (See FIG. 3A.) Accordingly, it is determined in step 235 that the image data from camera 132e will be transformed from a camera perspective to a mobile device perspective. Image data will continue to be obtained from camera 132g provided that patron 168 remains within area 133g and continues substantially along trajectory 137g.

In this example, a “handoff” indication is determined when patron 168 is at position 168′″, because patron 168 is assumed to be moving out of area 133g. (Step 255.) Another camera will be selected. If necessary, image data from the next camera will be transformed from a camera perspective to a mobile device perspective.

Similarly, the mobile device of patron 166 receives image data from camera 132c while patron 166 is within area 133c and moves along a trajectory that approximates one of the radii within angle 135c. The range of acceptable deviations between a patron trajectory and such a radius may be set according to the particular implementation, e.g., within a predetermined angle range, according to a distance between the camera and the nearest point along a line formed by a determined patron trajectory, etc.

When patron 166 reaches position 166′, it is determined that her trajectory has deviated beyond the parameters corresponding to camera 132c (a handoff indication determined in step 255), so other nearby cameras are evaluated for a handoff. (Step 260.) Because patron 166 is within area 133d and moving along a trajectory 137d that approximates one of the radii within angle range 135d, there is a “handoff” and data are obtained from camera 132d. When patron 166 reaches position 166″, it is determined that patron 166 is about to leave area 133d (a handoff indication determined in step 255), so other nearby cameras are evaluated for a handoff. (Step 260.) When patron 166 reaches position 166′″, it is determined that patron 166 is moving along a trajectory 137f that approximates one of the radii corresponding to camera 132f and is within a corresponding area 133f (not shown). Accordingly, there is a “handoff” and data are obtained from camera 132f.

It will be appreciated that organizing camera locations, viewpoints and/or fields of view according to some type of coordinate system provides various advantages. Some of these advantages will be discussed in further detail below. However, a variety of other methods may be used to associate cameras with areas of a casino. For example, camera locations could correspond with gaming machine locations, bar locations, retail locations and other locations in or near the casino. Therefore (and as noted in FIG. 1A), the camera locations do not necessarily correspond to a grid having uniform grid cells.

As noted elsewhere herein, the selecting step (e.g., step 205 or 215 of FIG. 2) may sometimes involve selecting more than one camera of a network of cameras. If so, the obtaining step (step 220) may comprise obtaining image data from each selected camera. A composite image may be formed based on image data from each selected camera. (Step 230.) Accordingly, some implementations of the invention involve forming composite images from multiple camera views. For example, it may often be the case that a mobile device is within an area corresponding to more than one camera. In some such implementations, instead of selecting the single best camera for providing image data to the mobile device, images from more than one camera may be provided.

Suppose, for example, that a mobile device is determined to be within area 133c and area 133e of FIG. 1D. In this example, the mobile device's orientation is determined to correspond roughly with the perspectives of cameras 132c and 132e. Here, image data from both camera 132c and camera 132e will be obtained. (Step 220 of FIG. 2.)

Image data acquired by sampling the same scene from different perspectives will be obtained with respect to different reference frames or coordinate systems. Therefore, when image data are obtained from more than one camera in step 220, some preferred implementations provide an image registration process in order to form a composite image that appears to be presented from a single frame of reference. Image registration is the process of transforming the different sets of image data into one coordinate system.

There are two general types of image registration algorithms: area based methods and feature based methods. Where two images are combined, one image may sometimes be referred to as a “reference image.” An image to be mapped onto the reference image may be referred to as the “target image.” In area-based image registration methods involve determining the structure of an image via correlation metrics, Fourier properties and/or other types of structural analysis. Feature-based image registration methods involve the correlation of image features such as lines, curves, points, line intersections, boundaries, etc.

Some implementations of the invention may involve producing composite images by applying a rotation matrix corresponding to a geometric rotation about a fixed origin. Plane homographies (or the like) may be used to map points in camera image planes to a mobile device image plane. Because camera locations and perspectives are known in advance, the process may be simplified by reference to such known geometries. For example, images from camera 132c and images from camera 132e may both be mapped into a mobile device image plane according to one of the methods described above with reference to FIG. 3A. Some type of image alignment and/or registration process may nonetheless be used to ensure that images from a first camera (e.g., images from camera 132c) are properly aligned with images from a second camera (e.g., images from camera 132e).

Further examples of the image alignment aspects of image registration are described below, in the context of aligning static images with camera images. Some of these techniques may also be used to align images from multiple cameras.

As described elsewhere herein, a mobile device may provide map data or other static images in some implementations of the invention. Some static data may show aspects of a casino floor, such as bars, restaurants, a hotel lobby, etc. Other static data (which are preferably updated automatically) may indicate changeable features, such as tournament information, meeting/conference information, entertainment-related information, wagering information, shopping information, dining information or information regarding other opportunities of potential interest.

For example, if the casino is using a “top down” or “push” type of server-based floor configuration, wager gaming machines may change theme, denomination, etc. In some instances, these changes may occur on a daily basis or even several times during the day (e.g., according to observed demographics/player preferences at different times of day). If a player wants to play a particular type of game, denomination, etc., it may be very useful to have an electronic guide that indicates where desired features may be found.

Some such implementations provide static images superimposed on the image data provided by one or more cameras (or vice versa). (See step 245 of FIG. 2.) Accordingly, some such implementations provide various techniques for aligning static images and video images. (See optional step 245 of FIG. 2.) Static images may be aligned with camera image data according to an image registration method, such as a feature-based image registration method.

Some image registration methods operate in the spatial domain, using textures, features, structures, etc., as matching criteria. Some such methods are automated versions of traditional techniques for performing manual image registration in which operators select matching sets of control points in each image to be registered. In some implementations, iterative algorithms such as Random Sample Consensus (“RANSAC”) may be used to estimate an optimal image registration.

For example, the method may involve matching points in a static image with points in a video image. The method may involve matching at least a first portion of a first polygon in a static image with a second portion of a second polygon in an image of the video data. The polygons could comprise, for example, sides and/or corners of one or more objects in the images, e.g., wager gaming machines, countertops, kiosks, furniture, gaming tables, etc. The orienting step may involve aligning one or more points in a static image with one or more corresponding points in an image of the video data.

However, alternative implementations may involve image registration algorithms that operate in the frequency domain. For example, a phase correlation method may be used. Phase correlation is a fast frequency-domain approach to estimate the shift needed to align two images. Applying one such phase correlation method to a pair of overlapping images produces a third image, which contains a single peak. The location of this peak corresponds to the relative translation between the two images. Some phase correlation methods use the Fast Fourier Transform to compute the cross-correlation between the two images, generally resulting in large performance gains as compared to spatial domain methods.

Some phase correlation methods can be extended to determine rotation and scaling between two images by first converting the images to log-polar coordinates. Due to properties of the Fourier transform, the rotation and scaling parameters can be determined in a manner invariant to translation. This single feature makes phase-correlation methods highly attractive vs. typical spatial methods, which must determine rotation, scaling, and translation simultaneously, though sometimes causing reduced precision of all three. Moreover, under some conditions phase correlation methods may be more robust than spatial-domain methods.

Some implementations of the invention involve providing additional information corresponding with a device location. For example, a benefit and/or opportunity corresponding with a device location may be offered. Such implementations may provide substantial opportunities, e.g., for targeting marketing and/or providing meaningful rewards to members of a player loyalty system.

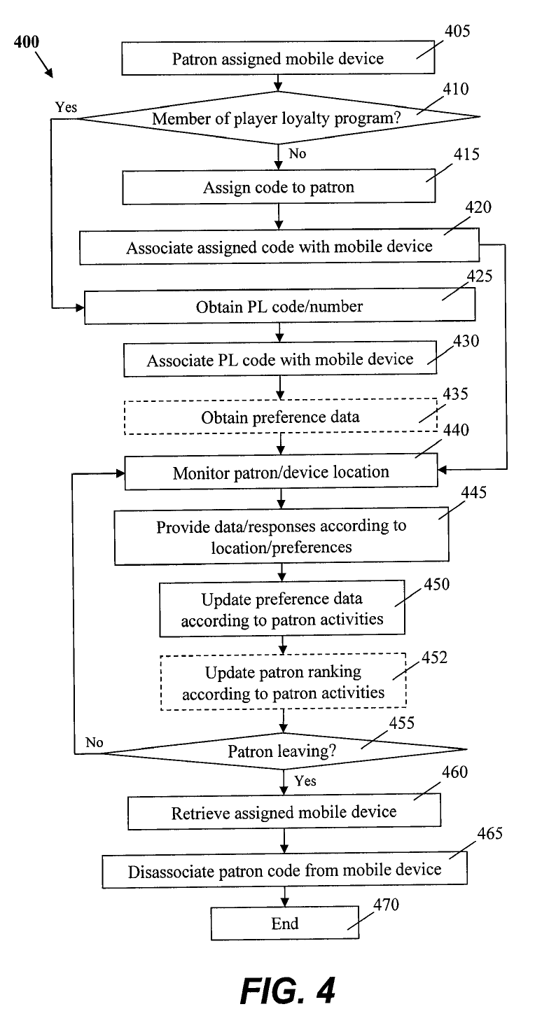

Some such implementations will now be described with reference to FIGS. 1A and 4. FIG. 4 depicts flow chart 400, which will now be referenced to describe some implementations of the invention. As with other implementations described herein, such implementations may include more (or fewer) steps than are indicated. Moreover, the steps of such implementations are not necessarily performed in the order indicated.

In step 405, a mobile device is assigned to a patron. For example, a patron may enter lobby 102 of gaming establishment 100a (see FIG. 1A) and receive a mobile device at hotel desk 174. In some implementations, a casino may provide a mobile device to its high-end customers, e.g., in connection with a stay in the hotel casino, with a promotion, a special event, etc. In other implementations, a mobile device may be provided to patrons who meet other predetermined criteria, to any interested casino patron, etc.

Step 405 may involve, e.g., identifying the patron, receiving a credit card, passport or driver's license as collateral, etc. Step 405 may also involve receiving a deposit or an authorization to charge the patron's account at a financial institution, e.g., a credit card authorization.

If it is determined that the patron is not a member of the gaming establishment's player loyalty program (as determined in step 410), a code (e.g., a number) is assigned to the patron. (Step 415.) The assigned code is then associated with an identification code, a serial number (or the like) corresponding to the mobile device. (Step 420.)

If it is determined in step 410 that the patron is a member of the gaming establishment, the corresponding player loyalty account code/number is obtained. (Step 425.) The player loyalty account number is then associated with an identification number, a serial number (or the like) corresponding to the mobile device. (Step 430.)

In some implementations, a patron may already possess a mobile device that can provide at least some of the functionality described herein. In such instances, the patron may choose to use his or her mobile device instead of having another device assigned by the gaming establishment. Nonetheless, if the patron is a player loyalty program member, the corresponding player loyalty account number may be obtained (step 425) and associated with an identification number, a serial number (or the like) corresponding to the mobile device. (Step 430.) If the patron is not a player loyalty program member, another code may be obtained or assigned (e.g., a drivers' license number, a passport number, a random number, the next available number in a series, etc.) and associated with a mobile device code/number.

In some instances, the mobile device will now be associated with a known patron of the casino and player preference data may be available. If the patron is a player loyalty program member, for example, patron preference data may be obtained from a player loyalty database in step 435. Such player preference data may be used in connection with directed marketing. High rollers could receive some promotions that others will not. Similarly, high rollers with certain preferences may receive offers that other high rollers will not.

Such patron preference information becomes even more useful when used in connection with some real-time navigation implementations of the invention. As the patron moves through the casino, the patron's location and/or that of the mobile device may be determined. (Step 440.) Offers or other information regarding nearby locations of potential interest may be presented to the patron. (Step 445.) Such information may be combined with an indication of how to reach the location(s).

For example, the information may involve a wager gaming opportunity in the vicinity of the mobile device location, such that a user of the device may be presented with a wager gaming opportunity that is relevant to his or her current location. The information may involve goods and/or services corresponding with the device location, e.g., regarding a drinking or dining opportunity at a nearby restaurant, bar, coffee shop, bakery, a sale at a nearby retail establishment, etc.

In some implementations, such information may be correlated with some feature(s) of navigation information that is presented to the patron. For example, in implementations that involve presenting “static” casino information, advertisements may be posted relating to static locations, e.g., “Do you realize that you are walking past Café Roma coffee shop? You qualify for a special offer!” “The Buffalo Steakhouse is right around the corner! Present your card for a $9.99 prime rib dinner!”

In other implementations, however, the information may not be directly associated with a location. For example, advertisements may be “projected” on a wall (e.g., a component of displayed “static” image data) displayed by the device.

In some such implementations, the mobile device may indicate the shortest path to a desired destination, e.g., to a desired game, restaurant, retail establishment, etc. The indication may be provided in any convenient fashion, e.g., via arrows, a colored line or pathway (“follow the yellow brick road”), etc. Similarly, the portable device may provide a “save” feature according to which a patron may save a desired location, e.g., of a Starbucks™, of a “lucky” EGM, of a poker room, of a hotel room, etc.

In some embodiments of the invention, a patron may indicate current desires or preferences by interacting with the portable device. If the patron is hungry, he or she may indicate a desire for information about places to eat, restaurant deals, etc., that are in the area. If the patron wants to shop, he or she may want to know about particular sales and opportunities to buy particular items of interest.

The reader will appreciate that some aspects of the invention may apply outside of the casino environment. For example, if a user of a mobile device needs gasoline, the user may want information regarding nearby gas stations, pricing of gasoline, etc.

When a patron is proceeding to a location, information, offers, advertisements, etc. regarding other locations along the route may be presented. Such information may be provided according to patron preferences, if known.

In addition to (or instead of) information provided on a display device, step 445 may involve providing information in audio form, e.g., “While you are on your way to the Starbucks™, you will be passing by the Aroma Bakery. You can probably smell some of their freshly-baked cakes and muffins now. We recommend that you try a complimentary slice of their gingerbread cake!” Audio could also be used to supplement the indicated directions to a location, e.g., “Turn left after this kiosk and head towards the Jungle Bar.”

In some implementations, audio data may be provided as an audio component of a tour. The tour may or may not be customized according to user preferences, depending on the implementation and on whether such data are available.

In this example, the preference data for at least some patrons will be updated according to patron activities. (Step 450.) In some such implementations, new preference data may be stored even if the patron is not a member of the casino's player loyalty program.

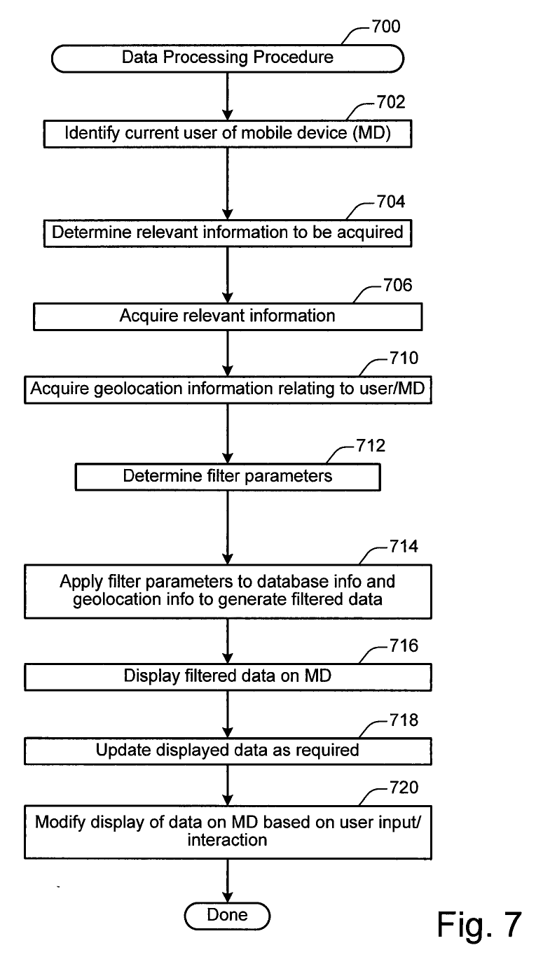

Some implementations of the invention involve a process of ranking current patrons of a casino. (Optional step 452.) This may be desirable for a variety of reasons, such as the need to vary the number of patrons tracked in real time according to the available casino resources, varying numbers of patrons at different times, a desire to ensure that certain types of patrons (e.g., high-level player loyalty program members) are tracked, etc. Relevant information is set forth in U.S. patent application Ser. No. 11/844,267, entitled “MULTIMEDIA PLAYER TRACKING INFRASTRUCTURE” (attorney docket no. IGT1P408/P-1221) and filed on Aug. 23, 2007 (see, e.g., FIG. 7 and the related description), which is hereby incorporated by reference in its entirety.

In this example, the patron will be rank/categorized according to the available data and monitored, e.g., according to the patron's category. As the patron's location is monitored (step 440), information, offers, etc., will be provided according to the patron's location. (Step 445.) Such data, responses, etc. will preferably be presented according to known preferences of the patron and/or information regarding the patron that may suggest such preferences. In this example, the data, responses, etc., may also be presented according to the patron's rank/category.

Various types of ranking and/or classification schemes may be employed, some of which are described in detail herein. A simple classification scheme may place all patrons into one of two categories: (1) patrons worth the dedication of identified resources (e.g., human resources, “comps,” etc.); and (2) patrons not worth the dedication of such resources.

However, alternative implementations of the invention may include multiple gradations of patrons who are deemed to be worth the dedication of identified resources. For example, there could be N categories of patrons deemed to be worth the dedication of identified resources, with different amounts of identified resources that are potentially available to and/or directed towards a patron.

FIG. 1A illustrates one such implementation, wherein N=2. Patrons 166a, 166b, 166c and 166d are placed in the highest category. Here, companion 168a of patron 166a and companion 168b of patron 166b are also placed in the highest category. Patrons 164 (two of whom may be seen in auditorium 124) are in the second-highest category. In this example, only patrons in these two categories will receive special services, directed marketing, etc.

In this example, patron 166c has previously been identified as a high-level patron according to a patron activities and a ranking/categorization process. When it is determined that high-level patron 166c is having a drink at bar 122, the beverage preferences of patron 166c are noted in real time, are associated with the patron ID code of patron 166c and are stored as patron data (e.g., in a player loyalty database). Moreover, the game preferences of patron 166c are determined (e.g., by reference to the player loyalty database). Gaming machine 127c is configured accordingly (e.g., by a server in control room 128). In some implementations of the invention, multiple nearby gaming machines (e.g., the bank of gaming machines that includes gaming machine 127c) may be configured according to the preferences of a group of patrons (e.g., patron 166c and other patrons nearby).

Special promotions (or other responses) may be directed to patron 166c according to the current location of patron 166c, e.g., via gaming machine 127c, via a mobile device such as a PDA, a mobile gaming device, a cellular telephone, etc., associated with patron 166c. Preferably, the promotion is tailored according to information regarding the preferences, or at least the demographics, of patron 166c.

In this example, it is observed that high-level patron 166b and companion 168b are at the entrance of restaurant 114. The staff of restaurant 114 is notified that patron 166b and companion 168b should be provided with top-level service. This notification may occur in any convenient fashion, e.g., via cellular phone, PDA, host device 142, etc. For example, patron 166b and companion 168b may be seated even if they do not have a reservation and restaurant 114 is very busy. They may be provided with free drinks while their table is being prepared. Their food and beverage selections may be noted in real time, associated with their patron ID codes and stored as patron data.

Similarly, when a high-level patron or companion is observed in or near a shop, their purchase types, amounts, etc., may be noted in real time, associated with their patron ID codes and stored as patron data. High-level service, discounts, free shipping, etc., may be provided. For example, patron 166d purchased chocolates for a friend at candy store 108. The amount and type of this purchase was noted in real time, associated with her patron ID code and stored as patron data. Patron 166d was pleased when candy store 108 shipped the chocolates to her friend at no charge. When a high-level patron or companion is observed to be leaving the gaming establishment, he or she may be given a special farewell.

Patrons 164 (two of whom may be seen in auditorium 124) are in the second-highest category. In this implementation, patrons in second-highest category will also receive an elevated level of customer service as compared to the average patron. A more moderate level of patron data will be acquired for in the second-highest category.

Patrons 164 and other patrons exiting auditorium 124 are creating traffic congestion near the exit. In some implementations of the invention, such temporal changes in traffic patterns are indicated to other patrons. For example, patron 166e was advised to go on his current route in order to avoid this congestion.

When it is determined that the patron is leaving, mobile devices provided by the casino will be retrieved, e.g., during checkout, by the valet service, etc. (Step 460.) The mobile device may have an associated RFID tag or the like to help prevent unauthorized removal from the casino. After the mobile device is retrieved, its identification number (or the like) is disassociated from the patron's number.

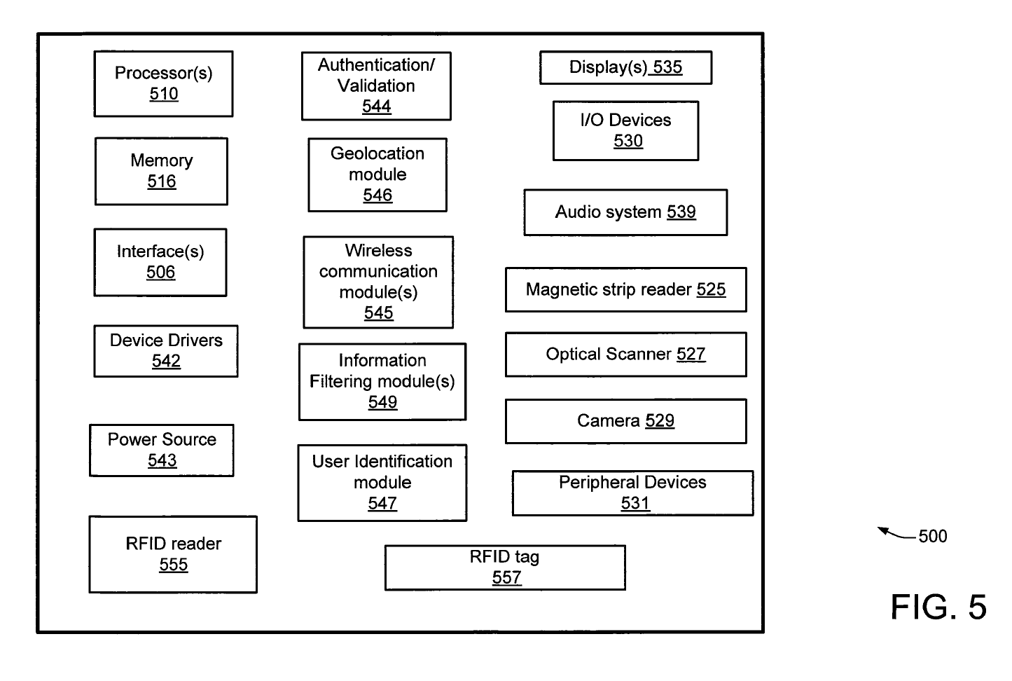

FIG. 5 is a simplified block diagram of an exemplary mobile device 500 in accordance with a specific embodiment of the present invention. As illustrated in the example of FIG. 5, mobile device 500 may include a variety of components, modules and/or systems for providing functionality relating to one or more aspects of the present invention. For example, as illustrated in FIG. 5, mobile device 500 may include one or more of the following:
At least one processor 510. In at least one implementation, the processor(s) 510 may include functionality similar to processor(s) 310 of FIG. 3.
Memory 516, which, for example, may include volatile memory (e.g., RAM), non-volatile memory (e.g., disk memory, FLASH memory, EPROMs, etc.), unalterable memory, and/or other types of memory. In at least one implementation, the memory 516 may include functionality similar to memory 316 of FIG. 3.
Interface(s) 506 which, for example, may include wired interfaces and/or wireless interfaces. In at least one implementation, the interface(s) 506 may include functionality similar to interface(s) 306 of FIG. 3.
Device driver(s) 542. In at least one implementation, the device driver(s) 542 may include functionality similar to device driver(s) 342 of FIG. 3.
At least one power source 543. In at least one implementation, the power source may include at least one mobile power source for allowing the mobile device to operate in a mobile environment.
Authentication/validation components 544 which, for example, may be used for authenticating and/or validating local hardware and/or software components and/or hardware/software components residing at a remote device. In at least one implementation, the authentication/validation component(s) 543 may include functionality similar to authentication/validation component(s) 344 of FIG. 3.
Geolocation module 546 which, for example, may be configured or designed to acquire geolocation information from remote sources and use the acquired geolocation information to determine information relating to a relative and/or absolute position of the mobile device. For example, in one implementation, the geolocation module 546 may be adapted to receive GPS signal information for use in determining the position or location of the mobile device. In another implementation, the geolocation module 546 may be adapted to receive multiple wireless signals from multiple remote devices (e.g., gaming machines, servers, wireless access points, etc.) and use the signal information to compute position/location information relating to the position or location of the mobile device.
Wireless communication module(s) 545. In one implementation, the wireless communication module 545 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
User Identification module 547. In one implementation, the User Identification module may be adapted to determine the identity of the current user or owner of the mobile device. For example, in one embodiment, the current user may be required to perform a log in process at the mobile device in order to access one or more features. Alternatively, the mobile device may be adapted to automatically determine the identity of the current user based upon one or more external signals such as, for example, an RFID tag or badge worn by the current user which provides a wireless signal to the mobile device for determining the identity of the current user. In at least one implementation, various security features may be incorporated into the mobile device to prevent unauthorized users from accessing confidential or sensitive information.
Information filtering module(s) 549.
One or more display(s) 535.
One or more radio frequency identification readers 555.
One or more radio frequency identification tags 557.
One or more user I/O Device(s) 530 such as, for example, keys, buttons, scroll wheels, cursors, touchscreen interfaces, audio command interfaces, etc.
Audio system 539 which, for example, may include speakers, microphones, wireless transmitter/receiver devices for enabling wireless audio and/or visual communication between the mobile device 500 and remote devices (e.g., radios, telephones, computer systems, etc.). For example, in one implementation, the audio system may include components for enabling the mobile device to function as a cell phone or two-way radio device.
Magnetic strip reader 525, which, for example, may be configured or designed to read information from magnetic strips such as those on credit cards, player tracking cards, etc.
Optical scanner 527, which, for example, may be configured or designed to read information such as text, barcodes, etc.
Camera 529 which, for example, may be configured or designed to record still images (e.g., digital snapshots) and/or video images.
Other types of peripheral devices 531 which may be useful to the users of such mobile devices, such as, for example: PDA functionality; memory card reader(s); fingerprint reader(s); image projection device(s); ticket reader(s); etc.

According to a specific embodiment, the mobile device of the present invention may be adapted to implement at least a portion of the features associated with the mobile game service system described in U.S. patent application Ser. No. 10/115,164, which is now U.S. Pat. No. 6,800,029, issued Oct. 5, 2004, (previously incorporated by reference in its entirety). For example, in one embodiment, the mobile device 500 may be comprised of a hand-held game service user interface device (GSUID) and a number of input and output devices. The GSUID is generally comprised of a display screen which may display a number of game service interfaces. These game service interfaces are generated on the display screen by a microprocessor of some type within the GSUID. Examples of a hand-held GSUID which may accommodate the game service interfaces are manufactured by Symbol Technologies, Incorporated of Holtsville, N.Y.

The game service interfaces may be used to provide a variety of game service transactions and gaming operations services. The game service interfaces, including a login interface, an input/output interface, a transaction reconciliation interface, a ticket validation interface, a prize services interfaces, a food services interface, an accommodation services interfaces, a gaming operations interfaces, a multi-game/multi-denomination meter data transfer interface, etc. Each interface may be accessed via a main menu with a number of sub-menus that allow a game service representative to access the different display screens relating to the particular interface. Using the different display screens within a particular interface, the game service representative may perform various operations needed to provide a particular game service. For example, the login interface may allow the game service representative to enter a user identification of some type and verify the user identification with a password. When the display screen is a touch screen, the user may enter the user/operator identification information on a display screen comprising the login interface using the input stylus and/or using the input buttons. Using a menu on the display screen of the login interface, the user may select other display screens relating to the login and registration process. For example, another display screen obtained via a menu on a display screen in the login interface may allow the GSUID to scan a finger print of the game service representative for identification purposes or scan the finger print of a game player.

The user identification information and user validation information may allow the game service representative to access all or some subset of the available game service interfaces available on the GSUID. For example, certain users, after logging into the GSUID (e.g. entering a user identification and a valid user identification information), may be able to access the food services interface, accommodation services interface, or gaming operation services interface and perform a variety of game services enabled by these game service interfaces. While other users may be only be able to access the award ticket validation interface and perform EZ pay ticket validations.

Using the input/output interface, a user of the GSUID may be able to send and receive game service transaction information from a number of input mechanisms and output mechanisms. The input/output interface may allow the GSUID user to select, from a list of devices stored in a memory on the GSUID, a device from which the GSUID may input game service transaction information or output game service transaction information. For example, the GSUID may communicate with a ticket reader that reads game service transaction information from bar-coded tickets. The bar-codes may be read using a bar-code reader of some type. The bar-coded tickets may contain bar-code information for awards, prizes, food services, accommodation services and EZ pay tickets. Additionally, the bar-coded tickets may contain additional information including player tracking information that relate the ticket to a specific game player. The information on a ticket is not necessarily in bar-code format and may be in any format readable by a particular ticket reader. As another example, the GSUID may input information from a card reader that reads information from magnetic striped cards or smart cards. The cards may contain player tracking information or other information regarding the game playing habits of the user presenting the card.

The GSUID may output game service transaction information to a number of devices. For example, to print a receipt, the GSUID may output information to a printer. In this game service transaction, the GSUID may send a print request to the printer and receive a print reply from the printer. The printer may be a large device at some fixed location or a portable device carried by the game service representative. As another example, the output device may be a card reader that is able to store information on a magnetic card or smart card. Other devices which may accept input or output from the GSUID are personal digital assistants, microphones, keyboard, storage devices, gaming machines and remote transaction servers.

The GSUID may communicate with the various input mechanisms and output mechanisms using both wire and wire-less communication interfaces. For example, the GSUID may be connected to a ticket reader by a wire connection of some type. However, the GSUID may communicate with a remote transaction server via a wire-less communication interface including a spread spectrum cellular network communication interface. An example of a spread spectrum cellular network communication interface is Spectrum 24 offered by Symbol Technologies of Holtsville, N.Y., which operates between about 2.4 and 2.5 Gigahertz. As another example, the GSUID may communicate with the printer via an infra-red wire-less communication interface. The information communicated using the wire-less communication interfaces may be encrypted to provide security for certain game service transactions such as validating a ticket for a cash pay out. Some devices may accommodate multiple communication interfaces. For example, a gaming machine may contain a wire-less communication interface for communication with the GSUID or a port where a cable from the GSUID may be connected to the gaming machine.

Another type of game service interface that may be stored on the GSUID is an award ticket validation interface. One embodiment of the award ticket interface may accommodate the EZ pay ticket voucher system and validate EZ pay tickets as previously described. However, when other ticket voucher systems are utilized, the award ticket validation interface may be designed to interface with the other ticket voucher systems. Using the award ticket validation interface, a game service representative may read information from a ticket presented to the game service representative by a game player using the ticket reader and then validate and pay out an award indicated on the ticket.

Typically, the award ticket contains game service transaction information which may be verified against information stored on a remote transaction server. To validate the ticket may require a number of game service transactions. For example, after the obtaining game service transaction information from the award ticket, the GSUID may send a ticket validation request to the remote transaction server using the spread spectrum communication interface and receive a ticket validation reply from the remote server. In particular, the validation reply and the validation request may be for an EZ pay ticket. After the award ticket has been validated, the GSUI may send a confirmation of the transaction to the remote server. In other embodiments, the award ticket interface may be configured to validate award information from a smart card or some other portable information device or validate award information directly from a gaming machine.

As game service transactions are completed, game service transaction information may be stored on a storage device. The storage device may be a remote storage device or a portable storage device. The storage device may be used as a back-up for auditing purpose when the memory on the GSUID fails and may be removable from the GSUID.

Another type of game service interface that may be stored on the GSUID is a prize service interface. As an award on a gaming machine, a game player may receive a ticket that is redeemable for merchandise including a bike, a computer or luggage. Using the prize service interface, the game service representative may validate the prize service ticket and then check on the availability of certain prizes. For example, when the prize service ticket indicates the game player has won a bicycle, the game service representative may check whether the prize is available in a nearby prize distribution center. The GSUID may validate the prize ticket and check on the availability of certain prizes by communicating with a remote prize server. Further, the game service representative may have the prize shipped to a game player's home or send a request to have the prize sent to a prize distribution location. The game service transactions needed to validate the prize ticket including a prize validation request and a prize validation reply, check on the availability of prizes and order or ship a prize may be implemented using various display screens located within the prize interface. The different prize screens in the prize service interface may be accessed using a menu located on each screen of the prize service interface. In other embodiments, the prize service interface may be configured to validate prize information from a smart card or some other portable information device or validate award information directly from a gaming machine.

Another type of game service interface that may be stored on the GSUID is a food service interface. As an award on a gaming machine or as compensation for a particular amount of game play, a game player may receive a ticket that is redeemable for a food service including a free meal, a free drink or other food prizes. Using the food service interface, the game service representative may validate the food service ticket and then check on the availability of certain prizes. For example, when the game player has received an award ticket valid for a free meal, the food service interface may be used to check on the availability of a dinner reservation and make a dinner reservation. As another example, the GSUID may be used to take a drink order for a player at a gaming machine. The GSUID may validate the food service ticket and check on the availability of certain food awards by communicating with a remote food server. The game service transactions needed to validate the food ticket, check on the availability of food services, request a food service and receive a reply to the food service request may be implemented using various display screens located within the food service interface. These display screens may be accessed using a menu located on each screen of the food service interface. In other embodiments, the food service interface may be configured to validate food service information from a smart card or some other portable information device.

Another type of game service interface that may be stored on the GSUID is an accommodation service interface. As an award on a gaming machine or as compensation for a particular amount of game play, a game player may receive a ticket that is redeemable for a accommodation service including a room upgrade, a free night's stay or other accommodation prize. Using the accommodation service interface, the game service representative may validate the accommodation service ticket and then check on the availability of certain accommodation prizes. For example, when the game player has received an award ticket valid for a room upgrade, the accommodation service interface may be used to check on the availability of a room and make a room reservation. As another example, the GSUID may be used to order a taxi or some other form of transportation for a player at a gaming machine preparing to leave the game playing area. The game playing are may be a casino, a hotel, a restaurant, a bar or a store.

The GSUID may validate the accommodation service ticket and check on the availability of certain accommodation awards by communicating with a remote accommodation server. The game service transactions needed to validate the accommodation ticket, check on the availability of accommodation services, request an accommodation service and receive a reply to the accommodation service request may be implemented using various display screens located within the accommodation service interface. These display screens may be accessed using a menu located on each screen of the accommodation service interface. In other embodiments, the accommodation service interface may be configured to validate accommodation service information from a smart card or some other portable information device.

Another type of game service interface that may be stored on the GSUID is a gaming operations service interface. Using the gaming service interface on the GSUID, a game service representative may perform a number of game service transactions relating to gaming operations. For example, when a game player has spilled a drink in the game playing area, a game service representative may send a request to maintenance to have someone clean up the accident and receive a reply from maintenance regarding their request. The maintenance request and maintenance reply may be sent and received via display screens selected via a menu on the screens of the gaming operations service interface. As another example, when a game service representative observes a damaged gaming machine such as a broken light, the game service representative may send a maintenance request for the gaming machine using the GSUID.

Another type of game service interface that may be stored on the GSUID is a transaction reconciliation interface. Typically, the GSUID contains a memory storing game service transaction information. The memory may record the type and time when particular game service transactions are performed. At certain times, the records of the game service transactions stored within the GSUID may be compared with records stored at an alternate location. For example, for an award ticket validation, each time an award ticket is validated and paid out, a confirmation is sent to a remote server. Thus, information regarding the award tickets, which were validated and paid out using the GSUID, should agree with the information regarding transactions by the GSUID stored in the remote server. The transaction reconciliation process involves using the transaction reconciliation interface to compare this information.

Another type of game service interface that may be stored on the GSUID is a voice interface. Using the spread spectrum cellular network incorporated into the GSUID, a game service representative may use the GSUID as a voice communication device. This voice interface may be used to supplement some of the interfaces previously described. For example, when a game player spills a drink the game service representative may send maintenance request and receive a maintenance reply using the voice interface on the GSUID. As another example, when a game player requests to validate a food service such as free meal, the game service representative may request a reservation at a restaurant using the voice interface on the GSUID.

Yet another game service interface that may be provided by the GSUID is a gaming device performance or metering data transfer interface. As mentioned, the GSUID preferably contains memory to record any wireless transfer of performance or metering data from the gaming device. More preferably, this wireless data transfer interface is particularly suitable for metering data in gaming devices which support multi-game platforms with multi-denomination inputs. For example, in a multi-game gaming device, which typically includes separate denomination meters for each game of the multiple games, a single gaming maintenance personnel is capable of downloading this metering data quickly and efficiently into the GSUID for subsequent data processing.

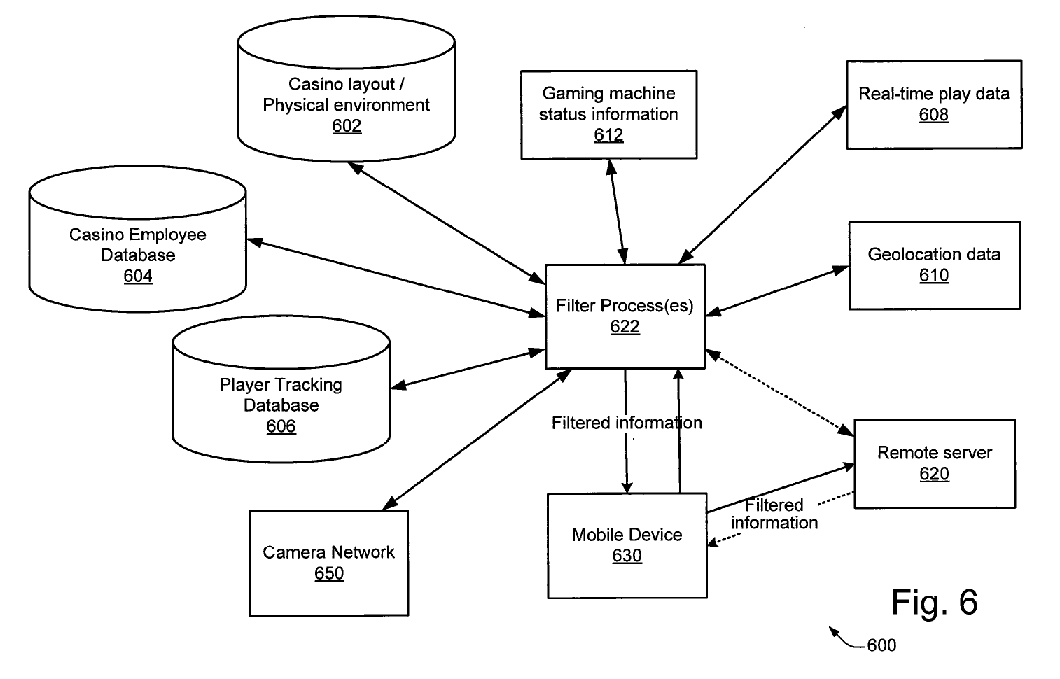

FIG. 6 shows a block diagram of system portion 600 which may be used for implementing various aspects of the present invention. As illustrated in the example of FIG. 6, system portion 600 may include at least one mobile device (MD) 630 which is configured or designed to display filtered information to a user. According to different embodiments, the filtered information may be acquired from a variety of information sources such as, for example one or more of the following:
Casino layout database(s) 602 which include information relating to casino floor layouts and/or physical environments.
Casino employee database(s) 604 which include information relating to casino employees and/or agents (such as, for example, employee names/ID, contact info, job types, work schedules, current locations, current status (e.g., active/inactive), etc.).
Player tracking database(s) 606 which include information relating to various players or patrons of the casino (such as, for example, names, contact info, personal preferences, game play history, etc.)
Real-time gaming or play data 608 which, for example, may be obtained from real-time game play information provided by one or more gaming machines on the casino floor. Some examples include: player wagering information, jackpot information, bonus game information, game play data, cash in/cash out information, etc.
Gaming machine status information 612 which, for example, may include real-time and/or non real-time information relating to the status of various gaming machine components, systems, modules, peripheral devices, etc. Some examples include information relating to: hopper status information, error information, security alerts, peripheral device(s) status information, etc.
Geolocation data 610 which, for example, may information relating to a current position or location of the MD and/or user of the MD. In one implementation, geolocation data may be acquired using external signals such as GPS signals, cellular telephone signals, wireless networking signals, radio frequency signals, and/or other types of local and/or global positioning signals. In at least one implementation, the geolocation data may be generated by using multiple wireless signals from multiple remote devices (e.g., gaming machines, servers, wireless access points, etc.) to compute current position/location information relating to the position or location of the mobile device.
Camera network 650, which may be provided as described elsewhere herein or in another convenient fashion.
Other information which may be useful for implementing at least one of the features of the present invention.

As illustrated in the example of FIG. 6, the various information may be processed by one or more filter processes (622) which may be adapted to use one or more filter parameters to generate filtered information to be displayed at the mobile device 630. According to different embodiments, different filter processes may be implemented at different devices or systems of the gaming network such as, for example: mobile device(s), gaming machine(s), server(s), and/or any combination thereof. For example, in one implementation the mobile device 630 may be adapted to acquire desired information from one or more sources, and to apply one or more filter processes to generate filtered information to be displayed on one or more displays of the mobile device. In a different implementation, a remote server (e.g., 620) may be adapted to acquire desired information from one or more sources, and to apply one or more filter processes to generate filtered information. The filtered information may then be transmitted via a wireless interface to the mobile device 630 for display to the user. In yet another implementation, one or more gaming machines may be adapted to apply one or more filter processes to locally generated information (e.g., real-time game play data, player data, gaming machine status information, etc.) to generate filtered information. The filtered information may then be transmitted via a wireless interface to the mobile device 630 for display to the user.

In one implementation, the filter process(es) may be adapted to utilize the geolocation data 610 in order to generate filtered information which is customized based on the relative location/position of the mobile device (and/or user) on the casino floor. For example, the filtered information may include identification of “hot” players or premier players within a predetermined radius of the mobile device's current location. Alternatively, the filtered information may include information relating to specific drop locations in need of servicing within a predetermined radius of the mobile device's current location.

In at least one implementation, the filtered and/or customized information which is displayed on the mobile device may automatically and/or dynamically change based upon the identity and/or privileges of the current user who is operating the mobile device. For example, in one implementation, the mobile device may be adapted to store employee profile information which, for example, may include information relating to casino employees or other persons such as, for example: employee name, employee ID, job description/responsibilities, access privileges, work schedule, etc. Additionally, the mobile device may be adapted to store customized, preconfigured filter parameters which are linked to each respective employee in the employee profile database. Upon determining the identity of the current user operating the mobile device, the customized, preconfigured filter parameters for the current user may be accessed and subsequently used during the information filter processing to generate appropriate filtered and/or customized information which is relevant to the current user. Thus, for example, if the current user is a casino host who's job responsibilities include identifying and greeting “hot” players (e.g., players who are betting and/or winning large amounts) and/or VIP players on the casino floor, the mobile device may use the current user's ID to automatically and a dynamically configure itself to display filtered information which includes identification of “hot” players and VIP players who are currently within a predetermined radius of the mobile device's current location. Alternatively, if the current user is a casino attendant who's job responsibilities include servicing gaming machine hoppers and verifying jackpot payoffs, the mobile device may use the current user's ID to automatically and a dynamically configure itself to display filtered information which includes identification of gaming machines within a predetermined radius of the mobile device's current location which are in need of hopper servicing or drops, and/or which currently require jackpot verification.

In an alternate implementation, the filtered and/or customized information displayed on the mobile device may be acquired without necessarily requiring that the mobile device generate geolocation data relating to its current location. For example, in one embodiment, the mobile device may be adapted to communicate, via a wireless interface, only with gaming machines or other devices on the casino floor which the mobile device believes are within a predetermined proximity to the mobile device. The mobile device may also be adapted to receive, via a wireless interface, information from gaming machines or other devices on the casino floor which are within a predefined range of the mobile device. For example, current implementations of Bluetooth™ technology allow a Bluetooth™ enabled device to communicate with other Bluetooth™ enabled devices which are within a 10 meter radius. Using such technology, the mobile device may be adapted to receive wireless information from gaming machines or other devices on the casino floor which are within a predetermined proximity (e.g., within 10 meters) of the mobile device. However, in at least one implementation, the mobile device will not receive wireless information from gaming machines or other devices on the casino floor which are outside the predetermined proximity.

FIG. 7 shows a flow diagram of a Data Processing Procedure 700 in accordance with a specific embodiment of the present invention. According to different embodiments, selected portions of the Data Processing Procedure 700 may be implemented at different devices or systems of the gaming network such as, for example, gaming machines, server(s), mobile device(s), and/or any combination thereof. In at least one implementation, the Data Processing Procedure 700 may be used for acquiring and generating the filtered and/or customized information which is to be displayed on a mobile device of the present invention.

At 702, a current user of the mobile device (MD) is identified. In one implementation, the identification of the current user may be implemented via the User Identification module (547, FIG. 5). In one implementation, the User Identification module may be adapted to determine the identity of the current user or operator of the mobile device. For example, in one embodiment, the current user may be required to perform a log in process at the mobile device in order for the user to access one or more features of the MD. Alternatively, the MD may be adapted to automatically determine the identity of the current user based upon one or more external signals such as, for example, an RFID tag or badge worn by the current user which provides a wireless signal to the mobile device for determining the identity of the current user.

According to a specific embodiment, once the current user of the MD has been identified, a determination may then be made (704) as to the various types of information to be acquired or accessed for use in generating the filtered and/or customized information to be displayed to the user via the MD. In one implementation, such a determination may involve accessing profile information relating to the identified user in order to facilitate the determination of which types of information will be relevant to the identified user. Such information may include, for example: information relating to casino floor layouts and/or physical environments; information relating to casino employees and/or agents; information relating to various players or patrons of the casino; information relating to real-time gaming or play data; gaming machine status information; real time directions to another area of the casino; real time alerts; messages from other MD users or casino management; staff schedules; etc.

As shown at 706, the desired information may then be acquired for example, by accessing one or more data sources such as those described, for example, in FIG. 6 of the drawings. Additionally, if desired, geolocation information relating to the current position or location of the MD may also be acquired and/or determined (710).

At 712, one or more filter parameters may be identified for use in generating the filtered and/or customized information. In at least one implementation, the selection of the specific filter parameters to be used may be based, at least in part, upon the identity and/or privileges of the current user who is operating the mobile device. For example, in one implementation, the mobile device may be adapted to store employee profile information as well as customized, preconfigured filter parameters which may be associated with specific parameters relating to the employee profile information. According to one embodiment, upon determining the identity of the current user operating the mobile device, the customized, preconfigured filter parameters associated with the current user may be accessed and subsequently used during the information filter processing to generate appropriate filtered and/or customized information which is relevant to the current user. Examples of such filter parameters may include, for example: physical proximity parameters (e.g., display relevant data which is within 50 feet of current MD position); path selection criteria (e.g., shortest available path, line of sight, as crow flies, etc.); parameters relating to the current user's job description (e.g., casino host, pit boss, security, maintenance, drops, casino attendant, gaming regulator, player, waiter/waitress, security staff, etc.); game play parameters; player parameters; information type parameters (e.g., display only selected types of information; do not display specified types of information; etc.); user selected parameters; time parameters (e.g. display machines that are scheduled for maintenance this week); etc.

As shown at 714, filtered and/or customized information may then be generated, for example, by applying the selected filter parameters and/or geolocation data to the acquired relevant information. According to different embodiments, different filter processes may be implemented at different devices or systems of the gaming network such as, for example: mobile device(s), gaming machine(s), server(s), and/or any combination thereof.

Once the desired filtered and/or customized information has been generated, the filtered and/or customized information may be displayed (716) to the current user via one or more displays of the MD. Additionally, the displayed information may be updated (718) based on a variety of conditions such as, for example: at scheduled and/or periodic intervals; upon demand (e.g., by the user, casino management, the player hitting an attendant button on the device, etc.); upon the occurrence of once or more predetermined events; upon the detection of a change in the information being displayed; upon the detection of a change in real-time data being displayed; upon the detection of a change in position or location of the MD; upon the detection of a change in the filter parameter selection; in response to user input; etc.

In at least one implementation, the MD may be adapted to dynamically modify (720) the format, type, scope and/or amount of information displayed based on user input or user interaction. For example, the MD may provide the user with a graphical interface for allowing the user to select the type and degree of filtered information to be displayed.

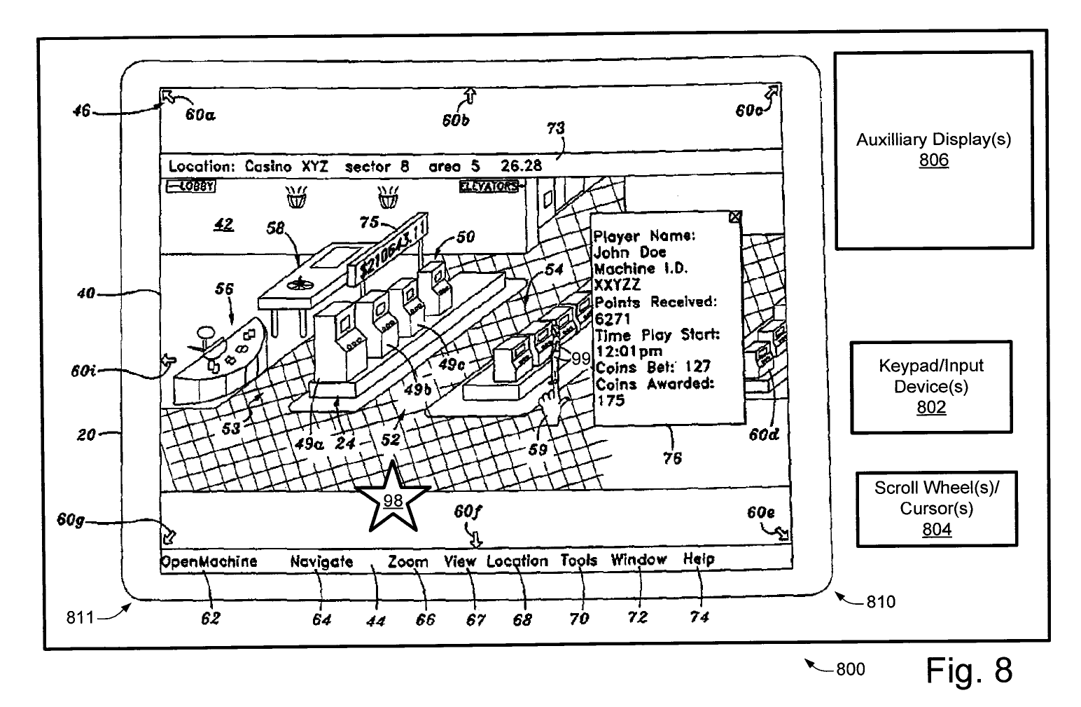

FIG. 8 shows a specific embodiment of a mobile device 800 which may be used for implementing various aspects of the present invention. As illustrated in the example of FIG. 8, mobile device 800 may include a primary display 810 and one or more auxiliary displays 806. Additionally, as illustrated in the example of FIG. 8, mobile device 800 may include one or more user input devices (e.g., 802, 804) such as, for example, keys, buttons, scroll wheels, jog wheels, touch screens, cursors, joysticks, touchpads, etc.

In the example of FIG. 8, there is provided a graphical user interface 811 which may be displayed on one or more of the displays of the mobile device (e.g., 810). In a preferred embodiment of the invention, the graphical user interface 811 is associated with at least one main application but capable of displaying information associated with one or more sub-applications or functions.

In one embodiment, the graphical user interface 811 is arranged to display information provided by an application or function which generates casino environment image information. In addition, in one or more embodiments, the graphical user interface 811 is arranged to display information provided from other applications or functions, and particularly those associated with individual functions or systems of a casino. These other applications or functions may be player tracking, casino accounting, security and the like.

In a preferred embodiment, the graphical user interface 811 includes a main window 40. The main window 40 may comprise a variety of elements having a variety of shapes and sizes. In general, the main window 40 comprises an element displayed on or by a device, such as a video screen.

In a preferred embodiment, when displayed, the main window 40 provides a gaming system environment information and permits interaction with an application executed by or function being performed by the mobile device 800 and, as described below, one or more other devices. In the embodiment illustrated, the main window 40 includes a display area 42, one or more menu elements 44 and one or more control or navigation icons 46.

In one implementation, graphical information regarding or representing a gaming environment is illustrated in the display area 42. The display area 42 preferably comprises a portion or field of the main window 40. This display area 42 portion of the main window 40 may be referred to as the data panel, window or viewport.

According to different embodiments, the information which is displayed in the display area 42 comprises a two-dimensional or three-dimensional representation of a gaming environment. The specific embodiment illustrated in FIG. 8 corresponds to a three-dimensional gaming environment representation. By gaming environment, it is meant the physical arrangement of components of the gaming system along with the related physical environment in which that system or its components reside. This environmental information may include, but is not limited to, the components of the gaming system, the physical arrangement of the components of the gaming system, and one or more portions of the physical environment in which the system is located, including the relationship of the components to the environment.

One example of such information is illustrated in FIG. 8. As illustrated, the information includes the representation of one or more of the gaming system devices 24 (as described above, the term gaming system device includes, but is not limited to, any component of the gaming system, including electronic, electromechanical, mechanical or other devices, elements or structures). These representations preferably comprise images, either actual images such as photographic information in digital form, or generated representations, of the gaming system devices 24 of the system 22. Preferably, if not an actual image of the gaming system device 24, the representation portrays information useful in identifying the gaming system device 24, such as the particular type of gaming system device. By “type” it is meant slot type machine, video type machine, table game, server, workstation or the like. In addition, the representation may more particularly identify the device 24, such as by particular game or manufacturer.

In a preferred embodiment, the representation of each gaming system device 24 is illustrated in a location on the display relative to all other gaming system devices 24 which represent the actual relative locations of the gaming system devices 24 of the gaming system 22 being portrayed in their actual physical environment.

In one embodiment, one or more aspects of the actual physical environment in which the components of the gaming system 22 are located is displayed. For example, a representation of a casino which is housing the gaming system 22 may be displayed. Once again, the aspects of the casino or other physical environment are preferably illustrated in relative and representative form to the actual physical environment, including size, relative location and the like.

An example of a portrayal of an actual gaming environment is illustrated in FIG. 8. As illustrated, the gaming system includes gaming system devices such as gaming machines 49a, b, c arranged in a first bank 50 of gaming devices. An isle 53 separates the first bank 50 of gaming devices from a second bank 54 of gaming devices. An isle 54 also separates the first bank 50 of gaming devices from a number of other gaming devices including a Blackjack table 56 and a Roulette wheel 58. Again, these displayed images correspond to an actual (in this case, exemplary) physical gaming environment.

Preferably, the information which is displayed to the user aids the user in correlating the illustrated information with the actual physical environment. A wide variety of information may be displayed to aid this function. For example, referring to FIG. 8, the information which is illustrated preferably includes details regarding the physical environment of the gaming system 22, which details aid the user of the mobile device in identifying the corresponding physical location of the individual components or devices of the system. This detail may include the illustration of casino walls, hallways, isles, significant fixtures such as light fixtures and signage, doors and the like. The detail may also include information such as the type of flooring, including reproduction of carpet designs, wall covering and a variety of other information.

Preferably, a variety of functions are provided for manipulating the information which is displayed in the display area 42. In one embodiment, a selector 59 is provided for selecting elements in the window 40. This selector 59 may comprise, as is known in the art, a mouse pointer or as illustrated, a hand with pointed finger. The selector 59 may be guided by a mouse, track-ball or a wide variety of other user input devices. Other means may be provided for selecting elements, such as by a menu or selection buttons, screen icons, etc,

As described, a plurality of navigation elements 46 may be provided. In one embodiment, the navigation elements 46 comprise directional arrows 60a, b, c, d, e, f, g, h, i. Selection of one of these arrows 60a-i preferably results in the display of information regarding an area of the gaming environment which is available in the direction of the arrow. For example, if a user selects the arrow 60d, then the field of view is shifted to the right. Information regarding the gaming system and related environment which lies in this direction is thus displayed in replacement of the information regarding the current location. In one embodiment, selection of a particular arrow 60 results in a predetermined distance of movement.

In addition, functions may be performed via menu selections. As illustrated, the menu 44 includes a number of menu elements. In one embodiment, the menu elements comprise “open machine” 62, “navigate” 64, “zoom” 66, “view” 67, “location” 68, “tools” 70, “window” 72, and “help” 74.

Upon selecting one of the menu selections, one or more functions associated with that selection may be presented to the user. These functions or selections may be illustrated in a hierarchical or other menu format. With respect to the “open machine” 62 selection, a user may be provided with a number of sub-selections, such as “open accounting,” “open security,” “open operating data” and the like. Each one of these sub-selections preferably results in the generation or display of certain information regarding a gaming system device which is illustrated in the display area 42, which device and information corresponds to an actual gaming system device of the gaming system 22.

With respect to the “navigate” 64 selection, a user may be provided with sub-selections such as “move right,” “move left,”, “move up,” “move down,” and the like. Other selections may be provided, such as a user's selection of a specifically designated area.

With respect to the “zoom” 66 selection, a user may be provided with sub-selections such as “zoom in,” “zoom out,” “percentage zoom,” “zoom to specified radius” (e.g., zoom to a radius of 30 feet from the current location of the mobile device), etc. Such selections may be used to change the magnitude of the size of displayed information. For example, “zoom out” preferably causes the scale of the displayed elements to reduce or become smaller, such that a larger representative area of the gaming environment is displayed in the display area 42. The “zoom in” features preferably causes the scale of the displayed elements to increase or become larger, such that a smaller representative area of the gaming environment is displayed in the display area 42.

With respect to the “view” 67 selection, a user may be provided with a number of sub-selections such as “camera view” or “archive view.” As described below, using such features a user may obtain a photographic image of a particular component or live video feed from a camera including the component within its field of view.

With respect to the “location” 68 selection, a user may be provided with options for the display of specific areas of a gaming environment. These locations may be pre-designated, such as “entrance” or the like.

With respect to the “tools” 70 selection, a user may be provided with a variety of function options such as changing the color of displayed information, contrast, importing and exporting of information, saving of data and the like.

With respect to the “window” 72 option, a user may be provided with options such as sizing of the window, closing or reducing the window 40. The user may also be provided with the option of making the display area 42 a full screen (i.e. no borders displayed). The user may also be provided with the option of changing the format of information displayed in the window 40, such as adding visible tool bars, changing the style of the navigation elements, and adding or removing information bars or areas. For example, in one embodiment, a “location” bar 73 may be displayed in the window 40. The “location” bar 73 may display information regarding the information of the location of the graphical components which are presently illustrated in the display area 42, such as the name of the casino and more detailed mapping information.

With respect to the “help” 74 selection, a user may be provided with a variety of help functions. These functions may include an index of help topics.

In one embodiment, the various functions which are provided by the menu 44 are enabled by software and/or hardware. For example, the mobile device 800 may include computer executable code arranged to “zoom” the information which is displayed in the display area 42. The mobile device may also be adapted to dynamically modify the filtered and/or customized information displayed, based on user input or user interaction. A variety of other menu selections may be provided, as is known. For example, menu selections may include “print” for printing displayed information.

In one or more embodiments, one or more of the elements which are displayed in the display area 42, such as represented gaming system devices, may comprise a container element. In general, a container element is an element which contains other elements or information. One or more of the elements displayed in the display area 42 may comprise application initiating elements. Application initiating elements comprise elements which, when selected, cause an application to be initiated or run.

In one embodiment, when a particular displayed element is selected, data associated with that element is displayed. The information which is displayed is dependent upon the element which is selected. For example, if the selected element is the gaming machine or table game, then information regarding the physical gaming machine or gaming table to which the displayed element corresponds is displayed. If the selected element is a progressive meter 75, then information regarding that device is displayed.

The manner by which the information is generated and displayed may vary. As described, the displayed element may comprise a container with which information is associated. For example, a displayed gaming system device may be configured similar to a file folder in a computer-based application window. Data from other applications or elements may be associated with the container so that when the container is selected, the associated information is accessible, accessed or displayed.

In another embodiment, the selection of a display element causes an underlying function or application to be initiated. Preferably, this function or application is arranged to generate and then display information associated with the display element. For example, upon selecting a particular gaming system device, an application may be initiated which polls various of the devices of the gaming system, such as servers or hosts, for information regarding that device.

The information may be displayed in a wide variety of manners. In one embodiment, the information may be displayed in a new window 76 which has characteristics separate from the main window 40. For example, the new window 76 may be moved, re-sized, and closed independent of the main window 40. In another embodiment, the information may be displayed in the main window 40.

In one embodiment, a user may be required to select by a menu or by touching the appropriate area on the display. In another embodiment, information may be presented when the selector 59 is moved over a particular element or as the user navigates through the virtual environment. For example, a window may automatically open and present information regarding a component positioned under the selector 59 or when touched by the user in a touch-display format.

The type of information which may be displayed may vary. In one embodiment, the information may comprise one or more selectable elements themselves, such as a menu of selections for the user. In another embodiment, specific information may be automatically configured and displayed. Such an arrangement is illustrated in FIG. 8. As illustrated, a variety of information may be displayed regarding the selected device. In the case of a gaming system device 24, the information may include the identification of the device, such as by serial number or other identifier. The information may include the location of the device. As described below, in an instance where the graphical gaming system information is arranged based upon predetermined grid arrangement which is correspondingly associated with the physical environment of the gaming system, then grid coordinates (i.e. 26:28 as illustrated) may be displayed.

The information may include a wide variety of information obtained from the actual gaming system device 24 which corresponds to the graphical representation. The information may also come from other sources, such as the individual servers or hosts. For example, accounting information such as total coins (or money) in and coins (or money) paid out by the gaming system device during periods of time may be displayed. Other information such as the operating status of the gaming system device and specific information about operating software may be provided from the gaming system device 24 via the game server 26.

The graphical user interface 811 may be configured in a wide variety of manners. For example, the navigation element, menu elements and the like may comprise text, buttons, symbols or take other forms. These elements, such as the arrows 60, menu elements and the like may have a variety of shapes and sizes.

In one embodiment, the display may be touch sensitive, allowing a user to select a display element directly. In such event, the various elements such as navigation arrows 60 and menu elements may be arranged as buttons which are sized for selection by the finger-tip touch of a user.

In one or more embodiments, one or more external windows (not shown) or other elements may be associated with the graphical user interface 811. Such windows or elements may be associated with, but not form a portion of, the main window 40 or its components. In one or more embodiments, the element may comprise a window in which information may be displayed, or may comprise a button, or panel including information, or other graphical elements having a variety of forms and configurations. In one embodiment, such an external window may be associated with an entirely different application from that which the graphical user interface 811 is associated. In another embodiment, a window may be displayed which is associated with an element of the graphical user interface 811.

In accordance with the present invention, there is provided a method of configuring a graphical user interface, such as the graphical user interface 811 described above. One embodiment of the invention comprises displaying a graphical representation of at least a portion of a gaming environment comprising a physical gaming system and its associated environment, and displaying filtered and/or customized information regarding one or more components of that gaming system.

A variety of other methods are contemplated as within the scope of the invention, and the steps may of the methods of the invention may be performed in a variety of sequences. In one embodiment, the method includes the step of generating a graphical user interface and displaying generated graphical gaming environment or gaming system information using the interface, such as in the display area of the interface. The method also includes the steps of accepting input from a user, such as for effecting navigation or requesting information regarding a particular displayed element.

In one embodiment, each gaming system device 24 or component is uniquely identifiable, and a graphical representation of a component is uniquely associated with an identified physical component. When a user selects a particular graphically represented gaming system device, a request for information regarding that gaming system device from a server or host is made by using the identifier for that device. This identifier may comprise a machine I.D., serial number or the like.

A variety of other embodiments of the invention are contemplated. In one embodiment of the invention, the mobile device 800 may be provided with a communication link to one or more cameras, such as casino security cameras. If desired, a user of the graphical user interface may be permitted to view the physical device to which the graphical representation corresponds using information from such a camera or cameras. As described above, a “view” 67 menu selection may be provided. By selecting a particular element in the display area 42 and the “view” selection, actual photographic information of the component in the physical environment may be presented to the user.

In one embodiment, when the user selects the “view” option, the mobile device 800 is arranged to obtain photographic information. Such information may be obtained from a particular camera or cameras through a communication link directly with the camera(s), or through a centralized security or other monitoring system through which data feeds from the one or more cameras is provided. The information may also comprise an archived image of the component.

For example, in one implementation, a camera or other image collection device may be configured to collect image information regarding one or more gaming system devices 24 and/or activities and objects (including players). By selecting the “view” 67 menu selection, a user may be permitted to select a particular camera, gaming system device 24 and/or area for which collected image information is desired. This image information may then be displayed to the user. The image information may comprise individual frame or streaming video information.

The photographic information may be displayed in a variety of manners. In one embodiment, the information is displayed in a new window located in the display area 42, in similar manner to the window 76. In one embodiment, the image information may be stored by the user. For example, when particular image information is selected, the user may utilize a “store” feature (such as provided in a sub-menu) to store the information for later use.

Of course, a wide variety of information may be provided to the user who is viewing the graphical user interface 811. For example, audio or audio and video information from the physical gaming environment may be provided.

The various components or elements of the graphical user interface 811 may be arranged in a variety of configurations. In general, it is desired, however, that the interface 811 provide a user with a consolidated “picture” of one or more portions of the gaming system and be capable of providing specific information regarding one or more components of that gaming system. In this regard, the gaming environment which is depicted may be referred to as a “virtual casino” in that it represents the casino in computer generated/presented format.

While it is preferred that the gaming system be represented in a three-dimensional form, other formats may be provided. In one embodiment, the gaming system may be represented in a two-dimensional format. In another embodiment, the gaming system may be represented using actual images of the gaming environment. For example, photographs may be taken of each gaming device 24 and the image of each particular gaming machine may be displayed in the represented environment with its photograph or other image. In another embodiment, live video information may be displayed to represent the environment. Other information may be imposed upon that image information to aid the user in identifying features and obtaining information. Alternatively, the image information may be imposed over a template, whereby when the user selects a particular displayed element, such as a particular gaming machine, the selection results in selection of the gaming machine as identified by its underlying template.

According to different embodiments, the graphical user interface 811 may also include an icon 98 representing a current position of location of the mobile device relative to other objects in the displayed gaming environment. In one implementation, the mobile device icon 98 may remain in a fixed position (e.g., in the center) of the graphical user interface 811 while other objects of the displayed gaming environment may automatically and dynamically change as the position of the mobile device changes. In an alternate embodiment, the mobile device icon 98 does not remain in a fixed position on the graphical user interface 811, and the user is able to scroll, pan, or otherwise change the portion of gaming environment which is being displayed.

In one embodiment of the invention, information regarding activities or events located remote from the user are displayed in real-time to the user. When a user selects a particular gaming system device 24, information regarding that device is displayed to the user in real time. For example, when a user selects a particular gaming machine 59, as illustrated in FIG. 8, information which is being generated by the gaming machine 59 is preferably provided to the user as it is generated. This information may comprise, for example, player events such as a player's input of a player card, coins in and coins out, and a wide variety of other information, such as identification of a game currently being played, results of games and the like.

In another embodiment, as also described, the user may obtain historical information. As illustrated in FIG. 8, such information may comprise information previously generated or information which was generated from previously generated information, such as actual win or hold percentage over time, coins in and coins out over time, number of games played over time, and similar information.

It will be appreciated that one or more components of a gaming environment or system may be located in more than one geographic location. For example, International Game Technology's MEGABUCKS™ system includes gaming system devices which are located in multiple casinos. In an embodiment of the invention, it is contemplated that the system may be modeled or represented in similar manner to that described above. In such an embodiment, at one “zoom” level, an overview graphical representation of the system may be provided, such as one in which all of the casinos having such machines are illustrated. A user may then select a particular casino or location and another level of information, such as a casino level detail as illustrated in FIG. 1 may be illustrated.

In this regard, the method and apparatus of the invention is not limited to presentation of information regarding a single gaming system or a portion of a gaming system at only a single location. It is contemplated that a user may be presented information regarding gaming systems at different casinos or a gaming system spread among or including multiple casinos. In such an embodiment, as described above, the user may be provided with a means for selecting the particular portion or area of the gaming system or the particular gaming system or casino property which the user would like information about. In an embodiment such as where the gaming system is distributed among multiple casinos or locations, the mobile device 800 may communicate with gaming system devices 24 at the individual casinos.

In one or more embodiments, means other than arrows or the like may be provided for changing the illustrated information or otherwise “navigating” the information. In one embodiment, navigation may be permitted using the selector 59. For example, as a user moves the selector 59 (such as with a track-ball) over the displayed gaming system information, the displayed information may “move” as well. For example, in the embodiment illustrated in FIG. 8, if a user were to move the selector 59 towards the area marked “elevators,” this portion of the displayed area would move towards the bottom of the display area 42, and additional information above that area would be displayed.

As noted, a variety of information regarding individual gaming system devices or components may be presented. This information may include device or structural data such as serial number, manufacturer and the like. The information may also include operational data, such as power on/off, malfunction and the like. The information may also include game-related information, such as amounts bet and awarded, percentage hold and the like. In one or more embodiments, the statistics from more than one gaming system device may be aggregated, such as by selecting an entire bank of gaming machines or a group of table games.

In one embodiment, graphical representations of players (e.g., 99) may be included. For example, in the event information is received that a particular gaming machine is in play by a player, the graphical representation of the environment may be updated to add a graphical representation of a player at that particular gaming machine. Likewise, graphical representation of players and dealers may be illustrated with respect to table games. In this manner, a user of the system may easily identify the gaming system devices which are current in use from those which are not.

In a preferred embodiment of the invention, as illustrated in FIG. 8, a user may obtain information regarding players and/or other persons or devices in the gaming environment such as, for example, casino employees, service technicians, gaming regulators, gaming machines, other mobile devices, etc. In one embodiment, the user may select a player (e.g., 99) to obtain information regarding that player. Information may be obtained whether the identity of the player is known or not. For example, if the identity of the player is not known, the gaming machine 25 may still provide information that a player is playing. In that event, a graphical representation (or actual image, such as obtained from a camera) of the player may be provided. When the user selects that representation, information may be displayed, such as collected and generated information regarding the time play began, coins in and coins out and the like.

As described above, a player may identify themselves by using a player tracking card or the like. In such an event, the user may obtain specific information regarding the player and the player's activities, such as tracked by a player tracking server (see, e.g., FIG. 1). This information may comprise any of the wide variety of information which is known to be collected or generated with such a system, such as the name of the player, bonus or awards points accrued to the player or the like, as illustrated in FIG. 8.

In this embodiment, a user may obtain information which allows the user to make decisions regarding the player. For example, by viewing the historical and/or real time play of a player as illustrated in FIG. 8, the user may elect to award the player a special bonus, such as a bonus number of accrued points which the player may utilized for free game play or prizes, as is known in the art of player rewards programs. In one embodiment, menu features may be provided for permitting the user to perform such functions, such as via the graphical user interface 811. In one embodiment, such actions may be transmitted over the gaming system (e.g., 22, FIG. 1) back to the player, so that the player is made aware of the award.

In a similar manner, a user may obtain information regarding other persons. For example, a user may obtain information regarding a dealer at a Blackjack table 56. A dealer may be required to log in when they begin dealing at a particular table 56. Further, equipment may be used, as described, for tracking game play, including bets and amounts paid at the table. By selection upon the representation of the dealer, the user may obtain information such as the identity of the dealer, their time at the table and related information.

In one or more embodiments, other options may be provided for manipulating the graphical information. For example, in one embodiment, a user may be permitted to move graphical elements, such as individual gaming system devices (such as representations of gaming machines or table games). In this manner, a user may be permitted to reconfigure the virtual gaming environment or casino and visually inspect the new configuration. This information may be useful in changing the actual physical environment/arrangement of the system.

For example, a user may utilize the graphical representation to reconfigure the gaming environment. For example, a casino may wish to reconfigure their gaming floor, such as by moving one or more gaming machines. A user may obtain a visual representation of the gaming floor as reconfigured by moving the representations of the gaming system devices 24. In one embodiment, the user may “drop and drag” the representations, or may use input commands to effect the movement.

In one embodiment, once one or more of the representations of the gaming devices 24 have been moved, reconfiguration information may be generated and output. This information may comprise, for example, the identification of moved devices and their new locations, such as in coordinate or other form. Technicians or workers may then utilize those instructions to move the physical devices to their intended locations.

In another embodiment, the physical gaming devices may be moved and then the system of the invention may utilize input information to change the represented environment. For example, technicians may input new location information for moved devices, and the system may then utilize that information to generate a new graphical representation for use by the user. In this manner, the representation is always accurate of the true environment.

In one embodiment, the user may be permitted to interact with individual gaming system device by sending information, such as control instructions, to the device. For example, a technician may query a device using the system and then send information to the device, such as a reset code. A user may also use the system to update control code, such as gaming machine game code using the system. In this arrangement, information or instructions are provided the virtual information host 56 to the one or more devices.

In one embodiment, a user may cause information to be transmitted to a gaming system device for use by a technician or similar party. For example, a user may obtain information regarding a particular gaming machine using the interface 811 and determine that the gaming machine should be reconfigured. The user may cause a work ticket to be printed from a ticket printer or dispenser at that gaming machine for use by the technician. Such work tickets may also be printed to provide trouble-shooting or similar information to a technician or other party at the gaming system device. Alternatively, the user of the mobile device may transmit a wireless message to an appropriate entity (e.g., service technician who also has a mobile device), to cause at least a portion of desired information to be displayed on the display of the receiving entity.

In general, the graphical user interface and system permit a party to obtain information regarding gaming system devices and transmit information to those devices. Advantageously, the interface provides a convenient means for recognizing and utilizing the information.

A variety of methods have been described above which, as indicated, may be implemented via the mobile device 800. For example, embodiments of the invention can be implemented as computer software in the form of computer readable code executed on a general purpose computer or other electronic device, or in the form of bytecode class files executable within a Java™ runtime environment running on such a computer/device, or in the form of bytecodes running on a processor (or devices enabled to process bytecodes) existing in a distributed environment (e.g., one or more processors on a network).

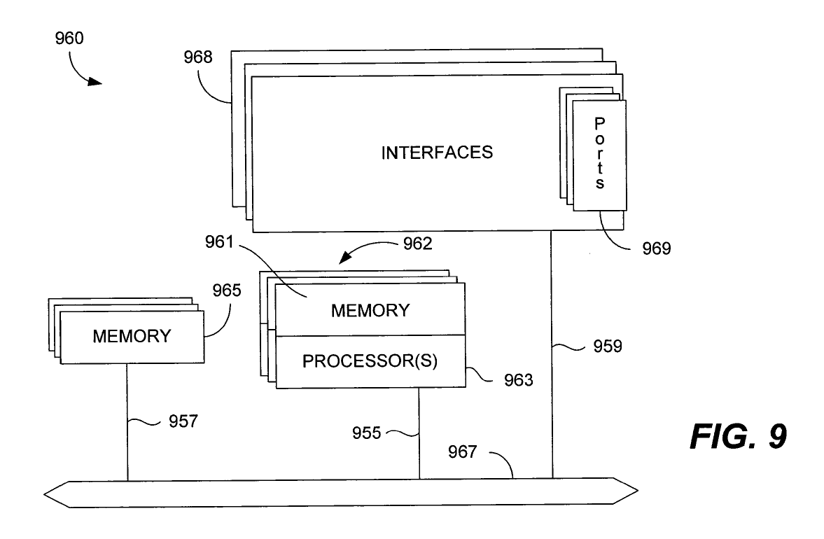

FIG. 9 illustrates an example of a network device that may be configured for implementing some methods of the present invention. Network device 960 includes a master central processing unit (CPU) 962, interfaces 968, and a bus 967 (e.g., a PCI bus). Generally, interfaces 968 include ports 969 appropriate for communication with the appropriate media. In some embodiments, one or more of interfaces 968 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 968 control such communications-intensive tasks as encryption, decryption, compression, decompression, packetization, media control and management. By providing separate processors for the communications-intensive tasks, interfaces 968 allow the master microprocessor 962 efficiently to perform other functions such as routing computations, network diagnostics, security functions, etc.

The interfaces 968 are typically provided as interface cards (sometimes referred to as “linecards”). Generally, interfaces 968 control the sending and receiving of data packets over the network and sometimes support other peripherals used with the network device 960. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 962 may be responsible for implementing specific functions associated with the functions of a desired network device. According to some embodiments, CPU 962 accomplishes all these functions under the control of software including an operating system and any appropriate applications software.

CPU 962 may include one or more processors 963 such as a processor from the Motorola family of microprocessors or the MIPS family of microprocessors. In an alternative embodiment, processor 963 is specially designed hardware for controlling the operations of network device 960. In a specific embodiment, a memory 961 (such as non-volatile RAM and/or ROM) also forms part of CPU 962. However, there are many different ways in which memory could be coupled to the system. Memory block 961 may be used for a variety of purposes such as, for example, caching and/or storing data, programming instructions, etc.

Regardless of network device's configuration, it may employ one or more memories or memory modules (such as, for example, memory block 965) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 9 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 9) or switch fabric based (such as a cross-bar).

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

For example, while the invention has been described principally with regard to casinos and related contexts, the invention is not limited to casino-related implementations. Instead, some camera-based and/or location-based infrastructures of the invention (and related methods) have wide applicability to other contexts. For example, many other types of enterprises could benefit from identifying valued customers or potential customers, providing real-time navigation services to them, collecting data regarding these individuals and/or providing enhanced services to them. Such enterprises may include convention centers, malls, amusement parks, retail establishments such as department stores, motor vehicle dealerships, power and sailboat dealerships, jewelers, watch dealers, etc. (particularly for those establishments that provide high-end merchandise), as well as high-end night clubs, restaurants and the like. Moreover, some such implementations of the invention could provide value in the security context, e.g., by providing infrastructure for identifying individuals and actions of concern, tracking them, etc.

We claim:

1. An apparatus for providing real-time navigation data, the apparatus comprising:
a network interface system comprising at least one network interface; and
a logic system comprising at least one logic device, the logic system configured to do the following:
receive data via the interface system regarding a device location;
select at least one camera having a viewpoint that corresponds with the device location;
obtain video data from at least one selected camera; and
transmit the video data to the device via the interface system.

2. The apparatus of claim 1, wherein the received data comprise data regarding an actual device location

3. The apparatus of claim 1, wherein the data received comprise data regarding a virtual device location.

4. The apparatus of claim 1, wherein the apparatus is configured to receive data via the interface system regarding a device orientation and to orient the video data according to the device orientation.

5. The apparatus of claim 1, wherein the selecting comprises selecting at least one camera of a network of cameras.

6. The apparatus of claim 1, wherein the selecting comprises selecting more than one camera of a network of cameras and wherein the obtaining step comprises obtaining video data from each selected camera, wherein the logic system is further configured to form a composite image from the video data from each selected camera.

7. The apparatus of claim 1, wherein selecting comprises selecting at least one camera deployed in a gaming establishment.

8. The apparatus of claim 1, wherein the logic system is further configured to offer a benefit corresponding with the device location.

9. The apparatus of claim 2, wherein the logic system is further configured to determine the actual device location according to an indication received via the interface system that a radio frequency identification (“RFID”) reader has read an RFID tag associated with the device.

10. The apparatus of claim 2, wherein the logic system is further configured to determine the actual device location according to a triangulation technique, based on a plurality of signals received via the interface system.

11. The apparatus of claim 3, wherein the video data correspond with the virtual location.

12. The apparatus of claim 3, wherein the logic system is further configured to prepare and transmit video data corresponding to a sequence of virtual device locations.

13. The apparatus of claim 4, wherein the orienting step comprises matching at least a first portion of a first polygon in a static image with a second portion of a second polygon in an image of the video data.

14. The apparatus of claim 4, wherein the orienting step comprises aligning a first point in a static image with a second point in an image of the video data.

15. The apparatus of claim 4, wherein the orienting step comprises applying a mathematical transformation of video data taken from a camera viewpoint to produce video data from a device viewpoint.

16. The apparatus of claim 4, wherein the device orientation comprises an actual device orientation.

17. The apparatus of claim 4, wherein the device orientation comprises a virtual device orientation.

18. The apparatus of claim 8, wherein the benefit comprises a wager gaming opportunity.

19. The apparatus of claim 8, wherein the benefit comprises at least one of goods or services.

20. The apparatus of claim 8, wherein the benefit corresponds to preference data for a user of the device.

21. The apparatus of claim 17, wherein the video data correspond with the virtual orientation.

22. The apparatus of claim 17, wherein the logic system is further configured to prepare and transmit video data corresponding to a sequence of virtual device orientations.

23. The apparatus of claim 20, wherein the logic system is further configured to obtain, via the interface system, the preference data from a player loyalty database.

24. An apparatus for providing real-time navigation data, the apparatus comprising:
an interface system comprising at least one wireless interface;
a display system comprising at least one display device;
orientation means for determining an orientation of the apparatus;
a memory system comprising at least one type of memory device; and
a logic system comprising at least one logic device, the logic system configured to do the following:
determine a location of the apparatus;
ascertain an orientation of the apparatus;
receive video data, via the interface system, from at least one selected camera having a viewpoint that corresponds with the device location and orientation; and
control the display system to display simultaneously the video data and static images of objects near the apparatus location, according to the apparatus location and orientation.

25. The apparatus of claim 24, wherein the determining step comprises determining an actual apparatus location and wherein the ascertaining step comprises determining an actual apparatus orientation, according to orientation data from the orientation means.

26. The apparatus of claim 24, wherein the determining step comprises determining a virtual apparatus location and wherein the ascertaining step comprises determining a virtual apparatus orientation.

27. The apparatus of claim 24, wherein the orientation means comprises a gyroscope system comprising at least one gyroscope.

28. The apparatus of claim 24, wherein the orientation means comprises an antenna.

29. The apparatus of claim 24, wherein the controlling step comprises controlling the display system to display static images of a gaming establishment.

30. The apparatus of claim 24, wherein the logic system is further configured to obtain static image data from the memory system.

31. The apparatus of claim 24, wherein the logic system is further configured to match at least a first portion of a first polygon in a static image with a second portion of a second polygon in an image of the video data.

32. The apparatus of claim 24, wherein the logic system is further configured to align at least one static image reference point with at least one corresponding video data reference point.

33. The apparatus of claim 24, wherein the logic system is further configured to apply a mathematical transformation of video data taken from a camera viewpoint to produce video data from an apparatus viewpoint.

34. The apparatus of claim 24, wherein the logic system is further configured to select a portion of a field of view of received video data corresponding with a displayed field of view of static image data.

35. The apparatus of claim 24, wherein the determining step comprises receiving location data via the network interface.

36. The apparatus of claim 24, wherein the logic system is further configured to control the display device to offer a benefit corresponding with the device location.

37. The apparatus of claim 24, further comprising an audio system comprising at least one sound-producing device, wherein the logic system is further configured to control the audio system to provide information corresponding with the device location.

38. The apparatus of claim 24, further comprising means for providing wagering games.

39. The apparatus of claim 25, further comprising a radio frequency identification (“RFID”) tag, wherein the determining step comprises receiving, via the network interface, a location of an RFID reader that has read the RFID tag.

40. The apparatus of claim 25, further comprising a radio frequency identification (“RFID”) reader, wherein the determining step comprises determining a location of an RFID tag read by the RFID reader.

41. The apparatus of claim 25, further comprising a Global Positioning System (“GPS”) unit, wherein the determining step comprises receiving location data from the GPS unit.

42. The apparatus of claim 26, wherein the static images and the video data correspond with the virtual location and the virtual orientation.

43. The apparatus of claim 26, wherein the logic system is further configured to control the display system to provide a virtual tour of an area by displaying static images corresponding to a sequence of virtual device locations and virtual device orientations.

44. The apparatus of claim 26, further comprising a user interface, wherein the determining step comprises receiving, via the network interface, at least one of a virtual device location or a virtual device orientation.

45. The apparatus of claim 37, wherein the logic system is further configured to control the audio device to offer a benefit corresponding with the device location.

46. The apparatus of claim 44, wherein the logic system is further configured to control the display system to display video data corresponding to the sequence of virtual device locations and virtual device orientations.

47. The apparatus of claim 44, further comprising an audio system comprising at least one sound-producing device, wherein the logic system is further configured to control the audio system to provide information corresponding to the sequence of virtual device locations and virtual device orientations.

48. A system for providing real-time navigation data, the system comprising:
means for determining a location of a device;
means for ascertaining an orientation of the device;
means for displaying static images of objects near the device location, according to the device orientation;
means for selecting at least one camera having a viewpoint that corresponds with the device location and orientation;
means for obtaining video data from at least one selected camera;
means for orienting the video data with the static images; and
means for presenting the video data on the device.

49. The system of claim 48, wherein the determining means comprises means for determining an actual device location and wherein the ascertaining means comprises means for determining an actual device orientation.

50. The system of claim 48, wherein the determining means comprises means for determining a virtual device location and wherein the ascertaining means comprises means for determining a virtual device orientation.
